(19) United States
(12) Patent Application Publication
(10) Pub. No.: US 2021/0136806 A1
(43) Pub. Date: May 6, 2021

(54) RESOURCE ALLOCATION MECHANISM FOR SINGLE CARRIER WAVEFORM

(71) Applicant: Intel Corporation, Santa Clara, CA (US)

(72) Inventors: Gang Xiong, Portland, OR (US); Jie Zhu, San Jose, CA (US); Daewon Lee, Portland, OR (US); Seunghee Han, San Jose, CA (US); Yushu Zhang, Beijing (CN)

(21) Appl. No.: 17/054,965

(22) PCT Filed: Oct. 16, 2019
(86) PCT No.: PCT/US2019/056502

§ 371 Date: Nov. 12, 2020

Related U.S. Application Data
(60) Provisional application No. 62/747,449, filed on Oct. 18, 2018.

(51) Int. Cl. H04W 72/12; H04L 27/26

(52) U.S. Cl. CPC H04W 72/1289; H04L 27/2605

(57) ABSTRACT

Systems, apparatuses, methods, and computer-readable media are provided for resource allocation for single carrier waveforms in systems operating at or above 52.6 Gigahertz (GHz) carrier frequencies. Disclosed embodiments include time domain resource allocation techniques and frequency domain resource allocation techniques for systems operating above at or 52.6 GHz carrier frequencies. Other embodiments may be described and/or claimed.

### RELATED APPLICATIONS

The present application claims priority to U.S. Provisional App. No. 62/747,449, filed Oct. 18, 2018, the contents of which is hereby incorporated by reference in its entirety.

### FIELD

Various embodiments of the present application generally relate to the field of wireless communications, and in particular, to resource allocation mechanisms for single carrier waveforms for communication systems operating above 52.6 GHz.

### BACKGROUND

Mobile communication has evolved significantly from early voice systems to today's highly sophisticated integrated communication platform. The next generation wireless communication systems, referred to as Fifth Generation (5G) or new radio (NR) systems, will provide access to information and sharing of data anywhere, anytime by various users and applications. NR is expected to be a unified network/system targeted to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich peoples' lives with better, simple and seamless wireless connectivity solutions. NR will enable everything to be connected by wireless and deliver fast, rich content and services.

In NR Release 15, the system design is based on carrier frequencies up to 52.6 GHz with a waveform choice of cyclic prefix orthogonal frequency-division multiplexing (CP-OFDM) for downlink (DL) and uplink (UL), and additionally, Discrete Fourier Transform-spread-OFDM (DFT-s-OFDM) for UL. However, for carrier frequency above 52.6 GHz, it is envisioned that a single carrier based waveform is needed in order to handle issues including low power amplifier (PA) efficiency and large phase noise.

### BRIEF DESCRIPTION OF THE FIGURES

FIG. 1 depicts an architecture of a system of a network in accordance with some embodiments. FIG. 2 illustrates a comparison between orthogonal frequency-division multiplexing (OFDM) and single carrier with frequency domain equalizer (SC-FDE) transmission schemes. FIGS. 3-5 illustrate example sub-block structures for single carrier waveform according to respective embodiments. FIG. 6 illustrates an example of time domain resource blocks (TRBs) in one slot according to various embodiments. FIG. 7 illustrates an example of configured bandwidth parts (BWPs) within system bandwidth (BW) according to various embodiments.

FIG. 8 illustrates an example infrastructure equipment in accordance with various embodiments. FIG. 9 illustrates an example of a platform in accordance with various embodiments. FIG. 10 illustrates an example of communication circuitry that may be used to practice the embodiments discussed herein. FIGS. 11 and 12 depict example processes for practicing the various embodiments discussed herein.

### DETAILED DESCRIPTION

Embodiments discussed herein provide resource allocation techniques for single carrier waveforms for systems operating above 52.6 Gigahertz (GHz) carrier frequencies. Communication systems operating above the 52.6 Gigahertz (GHz) carrier frequency may be referred to herein as “52.6 GHz systems” or the like. In particular, embodiments herein include time domain resource allocation techniques for 52.6 GHz systems, and frequency domain resource allocation techniques for 52.6 GHz systems. Other embodiments may be described and/or claimed.

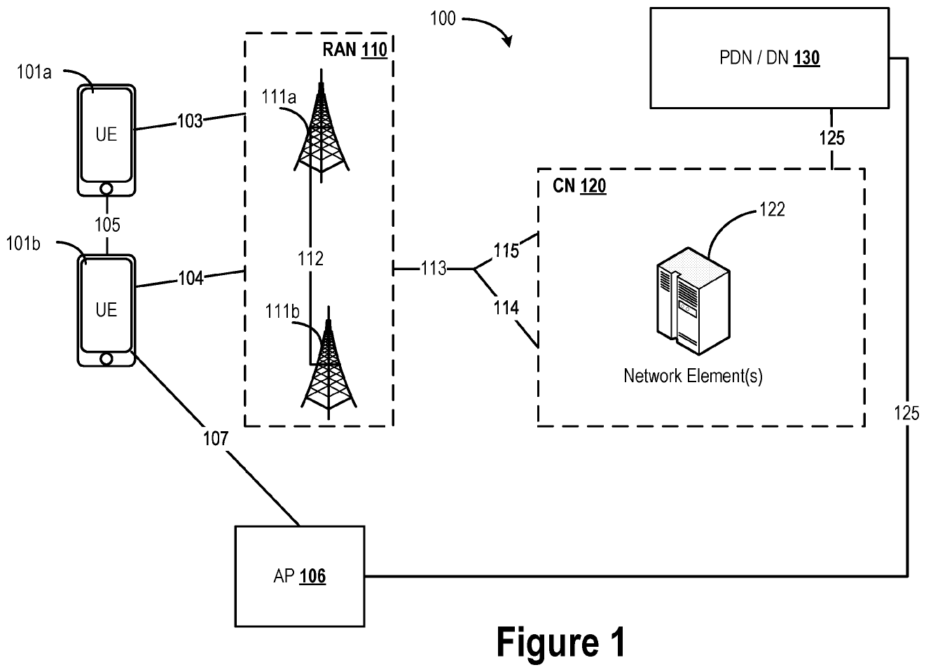

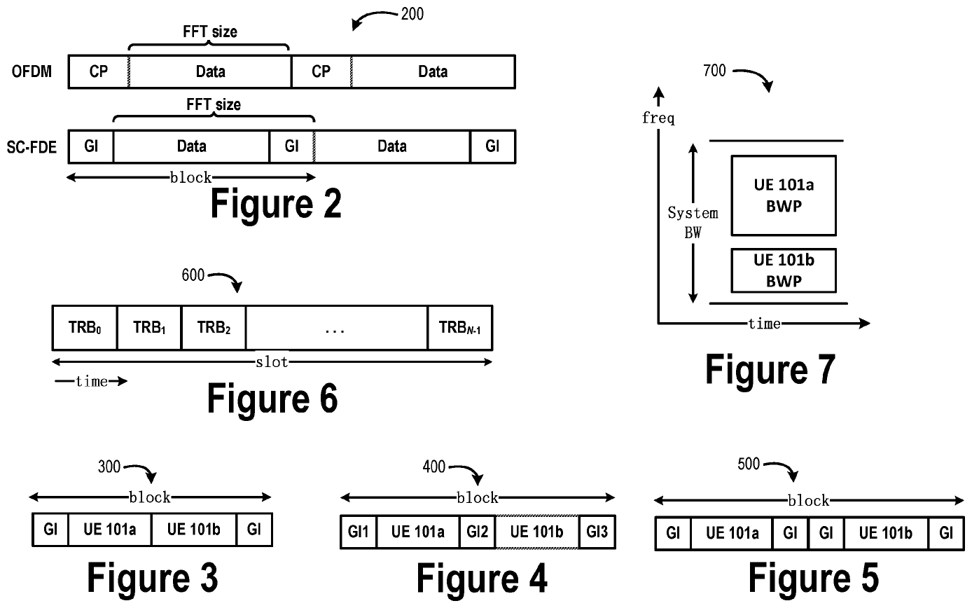

Referring now to FIG. 1, in which an example architecture of a system 100 of a network according to various embodiments, is illustrated. The following description is provided for an example system 100 that operates in conjunction with the Fifth Generation (5G) or New Radio (NR) system standards or Long Term Evolution (LTE) system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., Wireless Metropolitan Area Network (WMAN), Worldwide Interoperability for Microwave Access (WiMAX), etc.), or the like.

As shown by FIG. 1, the system 100 includes user equipment (UE) 101a and UE 101b (collectively referred to as “UEs 101” or “UE 101”). A UE 101 is any device with radio communication capabilities, such as a wireless communications interface, and describes a remote user of network resources in a communications network. In this example, UEs 101 are illustrated as smartphones, but may also comprise any mobile or non-mobile computing device, such as consumer tablet computers, wearable devices, desktop computers, laptop computers, in-vehicle infotainment (IVI) devices, head-up display (HUD) devices, Internet of Things (IoT) devices, embedded systems or microcontrollers, networked or “smart” appliances, and/or the like. The UEs 101 include various hardware elements such as baseband circuitry, memory circuitry, radiofrequency (RF) circuitry, and interface circuitry (e.g., input/output (I/O) interfaces), some or all of which may be coupled with one another via a suitable interconnect (IX) technology. The RF circuitry includes various hardware elements (e.g., switches, filters, amplifiers, digital signal processors (DSPs), etc.) configured to enable communication with wireless networks using modulated electromagnetic radiation through a non-solid medium. The electronic elements may be arranged as receive signal path (or receiving (Rx) RF chain) to down-convert received RF signals and provide baseband signals to the baseband circuitry, and arranged as a transmit signal path to up-convert baseband signals provided by the baseband circuitry and provide RF output signals to an antenna array via a front-end module for transmission. The baseband circuitry and RF circuitry allow the UEs 101 to connect or communicatively couple with a Radio Access Network (RAN) 110. In various embodiments, the UEs 101 may have multiple panels or multiple antenna arrays, and are configured to receive multiple independently scheduled data streams from different TRPs 111 in a multiple-DCI based multi-TRP/panel transmission. These aspects are discussed in more detail infra.

The UE 101b is shown to be configured to access an access point (AP) 106 via connection 107. The connection 107 can comprise a local wireless area network (WLAN) connection consistent with any IEEE 802.11 protocol, wherein the AP 106 may be a WiFi® router, gateway appliance, or the like. In this example, the AP 106 is shown to be connected to the Internet without connecting to the core network of the wireless system (described in further detail below). In various embodiments, the UE 101b, RAN 110, and AP 106 may be configured to utilize LTE-WLAN aggregation (LWA) operation and/or LTE/WLAN Radio Level Integration with IPsec Tunnel (LWIP) operation.

The RAN 110 is a set of RAN nodes 111 that implement a Radio Access Technology (RAT); the term “RAT” as used herein refers to a type of technology used for radio access such as NR, E-UTRA, WiFi/WLAN, and/or the like. The set of RAN nodes 111 in the RAN 110 are connected to one another via interface 112 and connected to the CN 120 through interface 113. In embodiments, the RAN 110 may be a Universal Terrestrial Radio Access Network (UTRAN) or Groupe Special Mobile (GSM)/Enhanced Datarates for GSM (EDGE) RAN (GERAN) when system 100 is an UTRAN or GERAN system, an Evolved UTRAN (E-UTRAN) when system 100 is an LTE or 4G system, or a next generation (NG) RAN or a 5G RAN when system 100 is an NR/5G system. The UEs 101 utilize connections (or channels) 103 and 104, respectively, each of which comprises a physical communications interface or layer. The term “channel” or “link” as used herein refers to any transmission medium, either tangible or intangible, which is used to communicate data or a data stream. Additionally, the term “link” as used herein refers to a connection between two devices through a RAT for the purpose of transmitting and receiving information. In FIG. 1, the connections 103 and 104 are illustrated as an air interface to enable communicative coupling, and can be consistent with cellular communications protocols, such as GSM, Code-Division Multiple Access (CDMA), Push-to-Talk (PTT) and/or PPT over cellular (POC), UMTS, LTE, 5G/NR, and/or the like. The UEs 101 may also directly exchange data via a Proximity Services (ProSe) or sidelink (SL) interface 105 comprising one or more physical and/or logical SL channels.

The RAN 110 includes one or more RAN nodes 111a and 111b (collectively referred to as “RAN nodes 111” or “RAN node 111”) that enable the connections 103 and 104. The RAN nodes 111 are infrastructure equipment that provide the radio baseband functions for data and/or voice connectivity between a network (e.g., core network (CN) 120) and one or more users (e.g., UEs 101). The RAN nodes 111 can be referred to as NodeBs 111 in UMTS systems, evolved NodeBs (eNBs) 111 in LTE systems, next generation NodeBs (gNBs) 111 or next generation eNBs (ng-eNBs) in 5G/NR systems, Road Side Units (RSUs) for vehicle-to-everything (V2X) implementations, and so forth. In some embodiments, each RAN node 111 may be a Transmission/Reception Point (TRP). In other embodiments, each RAN node 111 may have multiple antenna elements, where each antenna element may be an individual TRP.

The RAN nodes 111 can comprise ground stations (e.g., terrestrial access points) or satellite stations providing coverage within a geographic area (e.g., a cell). The RAN nodes 111 may be implemented as one or more dedicated physical devices such as a macrocell base stations, and/or a low power base stations for providing femtocells, picocells, or other like cells having smaller coverage areas, smaller user capacity, or higher bandwidth compared to macrocells. Any of the RAN nodes 111 can terminate the air interface protocol and can be the first point of contact for the UEs 101. In some embodiments, any of the RAN nodes 111 can fulfill various logical functions for the RAN 110 including, but not limited to, radio network controller (RNC) functions such as radio bearer management, UL and DL dynamic radio resource management and data packet scheduling, and mobility management.

In some embodiments, all or parts of the RAN nodes 111 may be implemented as one or more software entities running on server computers as part of a virtual network (e.g., a cloud RAN (CRAN), virtual baseband unit pool (vBBUP), or the like). In these embodiments, the RAN nodes 111 may implement a RAN function split where different protocol entities are operated by different elements. The term “element” as used herein refers to a unit that is indivisible at a given level of abstraction and has a clearly defined boundary. One or more RAN nodes 111 may represent individual distributed units (DUs) that are connected to centralized unit (CU) via respective F1 interfaces (not shown by FIG. 1). In these implementations, the gNB-DUs may include one or more remote radio heads or RFEMs, and the gNB-CU may be operated by a server that is located in the RAN 110 (not shown) or by a server pool in a similar manner as a CRAN/vBBUP.

The RAN nodes 111 may be configured to communicate with one another via interface 112. The interface 112 may include a user plane interface for carrying user plane data between the RAN nodes 111, and a control plane interface for carrying control signaling between the RAN nodes 111. The interface 112 may be an X2 interface 112 when the system 100 is an LTE system, and the interface 112 may be an Xn interface 112 when the system 100 is a 5G/NR system. In some embodiments, interface 112 may be a wireless backhaul connection.

In embodiments, the UEs 101 can be configured to communicate using Orthogonal Frequency Division Multiplexing (OFDM) communication signals with each other or with any of the RAN nodes 111 over a multicarrier communication channel in accordance with various communication techniques, such as, but not limited to, an OFDMA communication technique (e.g., for DL communications) or a Single Carrier Frequency Division Multiple Access (SC-FDMA) communication technique (e.g., for UL and ProSe/SL communications), although the scope of the embodiments is not limited in this respect. The OFDM signals can comprise a plurality of orthogonal subcarriers.

DL and UL transmissions may be organized into frames with 10 ms durations, where each frame includes ten 1 ms subframes, and each subframe includes an integer number of slots. Time-frequency radio resource grids may be used to indicate physical resources in the DL or UL in corresponding slots. Each column and each row of the DL resource grid corresponds to one OFDM symbol and one OFDM subcarrier, respectively, and each column and each row of the UL resource grid corresponds to one SC-FDMA symbol and one SC-FDMA subcarrier, respectively. There is one resource grid for a given antenna port p, subcarrier spacing (SCS) configuration and transmission direction (DL or UL). The frequency location of a subcarrier refers to the center frequency of that subcarrier. Each element in the resource grid for antenna port p and SCS configuration μ is called a resource element (RE) and is uniquely identified by (k, l)_{p,μ} where k is the index in the frequency domain (e.g., k is a subcarrier index relative to a reference or reference point) and l refers to the symbol position in the time domain relative to some reference point (e.g., l is an OFDM symbol index relative to a reference or reference point). RE (k, l)_{p,μ} corresponds to a physical resource and the complex value a_{k,l}^{(p,μ)}. In other words, a_{k,l}^{(p,μ)} is the value of RE (k, l) for antenna port p and SCS configuration μ. An antenna port is defined such that the channel over which a symbol on the antenna port is conveyed can be inferred from the channel over which another symbol on the same antenna port is conveyed. Two antenna ports are said to be quasi co-located (QCLed) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

A collection of REs make up a resource block (RB), which is usually defined as N_{sc}^{RB}=12 consecutive subcarriers in the frequency domain. Physical RBs (PRBs) blocks for subcarrier configuration μ are defined within a bandwidth part (BWP) and numbered from 0 to N_{BWP,i}^{size,μ}−1 where i is the number of the BWP. Virtual RBs (VRBs) are defined within a BWP and numbered from 0 to N_{BWP,i}^{size}−1 where i is the number of the BWP.

A BWP is a subset of contiguous common RBs for a given numerology μᵢ in BWP i on a given carrier. The UE 101 can be configured with up to four BWPs in the DL with a single DL BWP being active at a given time. The UE 101 is not expected to receive PDSCH, PDCCH, or CSI-RS (except for RRM) outside an active BWP. The UE 101 can be configured with up to four BWPs in the UL with a single UL BWP being active at a given time. The UE 101 does not transmit PUSCH or PUCCH outside an active BWP. For an active cell, the UE 101 does not transmit SRS outside an active BWP.

Common RBs are numbered from 0 and upwards in the frequency domain for SCS configuration μ. The center of subcarrier 0 of common RB 0 for SCS configuration μ coincides with ‘point A’. The relation between the common RB number n_{CRB}^{μ} in the frequency domain and resource elements (k, l) for SCS configuration μ is given by

$${n}_{CRB }^{μ} = ⌊ \frac{k}{{N}_{sc}^{RB}} ⌋ ,$$

where k is defined relative to point A such that k=0 corresponds to the subcarrier centered around point A.

Point A serves as a common reference point for RB grids and is obtained from the parameters offsetToPointA PCell DL and absoluteFrequencyPointA for all other cases. The parameter offsetToPointA represents the frequency offset between point A and the lowest subcarrier of the lowest RB, which has the SCS provided by the higher-layer parameter subCarrierSpacingCommon and overlaps with the SS/PBCH block used by the UE 101 for initial cell selection, expressed in units of RBs assuming 15 kHz SCS for FR1 and 60 kHz SCS for FR2. The parameter absoluteFrequencyPointA for all other cases where absoluteFrequencyPointA represents the frequency-location of point A expressed as in Absolute Radio-Frequency Channel Number (ARFCN).

There are several different physical channels and physical signals that are conveyed using RBs, PRBs, and/or individual REs. A physical channel corresponds to a set of REs carrying information originating from higher layers. Physical channels include physical UL channels (e.g., physical UL shared channel (PUSCH), physical UL control channel (PUCCH), physical random access channel (PRACH), etc.) and physical DL channels (e.g., physical DL shared channel (PDSCH), physical DL control channel (PDCCH), physical broadcast channel (PBCH), etc.). A physical signal is used by the physical layer (PHY) but does not carry information originating from higher layers. Physical signals include physical UL signals (e.g., Demodulation Reference Signal (DMRS or DM-RS), Phase-Tracking Reference Signal (PTRS), Sounding Reference Signal (SRS), etc.) and physical DL signals (e.g., DMRS, PTRS, Channel State Information Reference Signal (CSI-RS), Primary Synchronization Signal (PSS), Secondary Synchronization Signal (SSS), etc.).

The PDSCH carries user data and higher-layer signaling to the UEs 101, and the PDCCH carries DL resource assignment information for receiving the PDSCH. Each UE 101 monitors a set of PDCCH candidates on one or more activated serving cells as configured by higher layer signaling for control information (e.g., Downlink Control Information (DCI)), where monitoring implies attempting to decode a set of PDCCH candidates according one or more monitored DCI formats (e.g., DCI formats 0 through 6-2 as discussed in section 5.3.3 of 3GPP TS 38.212 v15.3.0 (2018-09) (hereinafter “TS 38.212 v15.3.0”), DCI formats 0_0 through 2_3 as discussed in section 7.3 of TS 38.212 v15.3.0, or the like). The DCI includes, inter alia, DL assignments and/or UL scheduling grants including, for example, modulation and coding format, resource allocation, and HARQ information, among other information/commands. Each UE 101 monitors (or attempts to decode) respective sets of PDCCH candidates in one or more configured monitoring occasions according to UE or cell-specific search spaces (for LTE/4G), or monitors (or attempts to decode) respective sets of PDCCH candidates in one or more configured monitoring occasions in one or more configured Control Resource Sets (CORESETs) according to corresponding search space configurations (for NR/5G). A CORESET includes a set of PRBs with a time duration of 1 to 3 OFDM symbols. The REGs and CCEs are defined within a CORESET with each CCE including a set of REGs. Interleaved and non-interleaved CCE-to-REG mapping are supported in a CORESET. Each REG carrying PDCCH carries its own DMRS.

PDSCH transmissions are scheduled by DCI format 1_0 and DCI format 1_1. DCI format 1_0 is used for the scheduling of PDSCH in one DL cell and DCI format 1_1 is used for the scheduling of PDSCH in one cell. DCI format 1_0 includes, inter alia, a frequency domain resource assignment, a time domain resource assignment, and other fields/elements as discussed in TS 38.212 v15.3.0. DCI format 1_1 includes, inter alia, a bandwidth part indicator, a frequency domain resource assignment, a time domain resource assignment, antenna port(s) where the number of CDM groups without data of values 1, 2, and 3 refers to CDM groups {0}, {0,1}, and {0, 1, 2} respectively and the antenna ports {p₀, . . . p₀₋₁} are determined according to the ordering of DMRS port(s) given by Tables 7.3.1.2.2-1/2/3/4 of TS 38.212 v15.3.0, and other fields/elements as discussed in TS 38.212 v15.3.0.

The RAN 110 is shown to be communicatively coupled to a core network (CN) 120 comprising one or more network elements 122, which are configured to offer various data and telecommunications services to customers/subscribers (e.g., users of UEs 101) who are connected to the CN 120 via the RAN 110. The term “network element” as used herein refers to physical or virtualized equipment and/or infrastructure used to provide wired or wireless communication network services, and may be considered synonymous with, and/or referred to as, a networked computer, networking hardware, network equipment, network node, router, switch, hub, bridge, radio network controller (RNC), RAN device, RAN node, gateway, server, cloud node, Virtualized Network Function (VNF), NFV Infrastructure (NFVI), and/or the like. The network elements 122 may be one or more server computer systems, which may implement various CN elements (e.g., network functions (NFs) and/or application functions (AFs)) such as those discussed herein. The components of the CN 120 may be implemented in one physical node or separate physical nodes including components to read and execute instructions from a machine-readable or computer-readable medium (e.g., a non-transitory machine-readable storage medium). In some embodiments, Network Function Virtualization (NFV) may be utilized to virtualize any or all network node functions via executable instructions stored in one or more computer-readable storage mediums (described in further detail below). A logical instantiation of the CN 120 may be referred to as a network slice, and a logical instantiation of a portion of the CN 120 may be referred to as a network sub-slice. As used herein, the terms “instantiate,” “instantiation,” and the like refers to the creation of an instance, and an “instance” refers to a concrete occurrence of an object, which may occur, for example, during execution of program code. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more NFs/AFs.

In embodiments where the CN 120 is an Evolved Packet Core (EPC) in LTE systems, the one or more network elements 122 may include or operate one or more Mobility Management Entities (MMEs), Serving Gateways (S-GWs), PDN Gateways (P-GWs), Home Subscriber Servers (HSSs), Policy Control and Charging Rules Functions (PCRFs), and/or other like LTE

CN elements. In these embodiments, the E-UTRAN 110 may be connected with the EPC 120 via an S1 interface 113. In these embodiments, the S1 interface 113 is split into two parts: an S1-U interface 114 to carry traffic data between the RAN nodes 111 and the S-GW, and the S1-MME interface 115, which is a signaling interface between the RAN nodes 111 and MMEs. Additionally, the P-GW within the EPC 120 may route data packets between the EPC 120 and external networks such as a network including a Packet Data Network (PDN) 130 via an Internet Protocol (IP) interface 125. The PDN 130 may be an operator external public, a private PDN (e.g., enterprise network, cloud computing service, etc.), or an intra-operator PDN (e.g., for provision of IMS and/or IP-CAN services).

In embodiments where the CN 120 is a 5GC 120, the network elements 122 may implement one or more instances of an Authentication Server Function (AUSF), Access and Mobility Management Function (AMF), Session Management Function (SMF), Network Exposure Function (NEF), Policy Control Function (PCF), NF Repository Function (NRF), Unified Data Management (UDM) entity, AF, User Plane Function (UPF), Short Message Service Function (SMSF), Non-3GPP Interworking Function (N3IWF), Network Slice Selection Function (NSSF), and/or other like NR NFs. In such embodiments, the NG-RAN 110 may be connected with the 5GC 120 via an NG interface 113. In these embodiments, the NG interface 113 may be split into two parts, an NG-U interface 114, which carries traffic data between the RAN nodes 111 and a UPF, and the NG-C interface 115, which is a signaling interface between the RAN nodes 111 and AMFs. Additionally, the UPF within the 5GC 120 may perform packet routing, filtering, inspection, forwarding, etc., between the 5GC 120 and external networks such as a data network (DN) 130 via an IP interface 125. The DN 130 may represent one or more DNs including one or more Local Area DNs (LADNs), and may be an operator external public, a private PDN, an intra-operator PDN as discussed previously.

The CN 120 is shown to be communicatively coupled to PDN/DN 130 via an IP communications interface 125. The PDN/DN 130 may include one or more application servers (AS). The application server(s) (and the network element(s) 122) comprise one or more physical and/or virtualized systems for providing functionality (or services) to one or more clients (e.g., UEs 101) over a network. Such servers may include various computer devices with rack computing architecture component(s), tower computing architecture component(s), blade computing architecture component(s), and/or the like. The server(s) may represent a cluster of servers, a server farm, a cloud computing service, or other grouping or pool of servers, which may be located in one or more datacenters. The server(s) may also be connected to, or otherwise associated with one or more data storage devices (not shown). Generally, the AS(s) 130 offer applications or services that use IP/network resources. As examples, the server(s) may provide traffic management services, cloud computing services, content streaming services, immersive gaming experiences, social networking and/or microblogging services, one or more communication services (e.g., VoIP sessions, PTT sessions, group communication sessions, social networking services, etc.), and/or other like services for the UEs 101 via the CN 120.

FIG. 2 illustrates a comparison between orthogonal frequency-division multiplexing (OFDM) and single carrier with frequency domain equalizer (SC-FDE) transmission schemes. In FIG. 2, the OFDM based transmission scheme includes DFT-s-OFDM, and a cyclic prefix (CP) is inserted at the beginning of each data block. The last data symbol(s) in each data block is/are repeated as the CP. Additionally, a Fast Fourier Transform (FFT) size for the OFDM based transmission scheme includes the data portion of the data block. Typically, the length of CP exceeds the maximum expected delay spread in order to overcome inter-symbol interference (ISI).

For the SC-FDE transmission scheme, a predetermined sequence, such as a CP, can be inserted into a guard interval (GI) at the beginning of each data block, or at both the beginning and end of each data block. The sequence(s) used for GI may be a unique word (UW), a CP, or some other known sequence. The FFT size for the SC-FDE transmission scheme is the data portion plus the subsequent GI. Further, a linear equalizer in the frequency domain of the SC-FDE transmission scheme can be employed to reduce receiver (Rx) complexity. Compared to OFDM, the SC-FDE transmission scheme can reduce Peak to Average Power Ratio (PAPR), which may allow the use of a less costly power amplifier.

The GI, UW, or CP is inserted in around the data block in order to partition individual data blocks from one another. Because, in most implementations, one data block may have a relatively large numbers of samples, in various embodiments, individual data blocks are partitioned into multiple sub-blocks (see e.g., FIGS. 3-5). Partitioning data blocks into sub-blocks allows for multiple UEs 101 to be multiplexed within one data block. For example, when a UE 101 has a relatively small packet size (e.g., smaller than a preconfigured threshold) for conveying data or control channel signaling, the whole data block may not be needed for a single carrier waveform (e.g., SC-FDE) transmission. In other words, the data or control channel information may only occupy a partial data block in various embodiments.

To allow efficient transmission of data or control channel signaling in the time and frequency domains, certain mechanisms may need to be considered for resource allocation for single carrier waveforms (e.g., SC-FDE waveform). As mentioned previously, the NR Release 15 system design is based on carrier frequencies up to 52.6 GHz with a waveform choice of CP-OFDM for DL and UL, and DFT-s-OFDM for UL. However, a single carrier based waveform for carrier frequencies above 52.6 GHz is needed in order to handle issues related to low power amplifier (PA) efficiency and large phase noise.

Embodiments herein include time domain resource allocation techniques for 52.6 GHz systems, and frequency domain resource allocation techniques for 52.6 GHz systems. Using single carrier waveforms enables the network (NW) to configure sub-band based transmissions, where individual UEs 101 are assigned or allocated with a certain time and/or frequency resources for data transmissions above 52.6 GHz. This is different than using OFDM waveforms, which typically utilize an entire bandwidth (BW). These embodiments are discussed in more detail infra.

### Time Domain Resource Allocation for 52.6 GHz Systems

As shown by FIG. 2, for single carrier waveform (e.g., SC-FDE waveform), the data transmission is generally block-based. To reduce channel equalization computation costs/overhead, a GI of a known sequence, such as a UW or CP, is inserted before and after the data block. For the transmission of data or control channel information with a relatively small packet size, the whole data block may not be needed, which indicates that the data or control channel may only occupy partial data block. To allow efficient transmission of data or control channel information in the time domain, time domain resource allocation embodiments include utilizing a sub-block based structure for single carrier waveform transmission schemes (e.g., SC-FDE waveform) for 52.6 GHz systems.

FIG. 3 illustrates an example sub-block structure 300 for a single carrier waveform according to a first time domain resource allocation embodiment. In this embodiment, a data block is partitioned into multiple sub-blocks, and no additional GI is inserted in the middle of the data block, or between the sub-blocks. Additionally, different sub-blocks may be assigned or allocated to different UEs 101, which can be multiplexed in a time division multiplexing (TDM) manner. In the example of FIG. 3, UE 101a and UE 101b are allocated respective sub-blocks of equal size. Further, the GI is only inserted before and after the data block, and no GI is inserted between the two sub-blocks. With the transmission block structure of the first embodiment, each UE 101 may process the whole data block in order to access its own sub-block(s). This embodiment may be appropriate for PDCCH and/or PDSCH transmissions with a small payload size such as, for example, a paging message or short message of a paging channel carried by PDSCH can be transmitted in one sub-block.

FIG. 4 illustrates an example sub-block structure 400 for a single carrier waveform according to a second time domain resource allocation embodiment. In this embodiment, one data block is partitioned into multiple sub-blocks, each of which has its own GIs at both sides of the data portion of the sub-block. In the example of FIG. 4, UE 101a and UE 101b are allocated respective sub-blocks of equal size, where a first GI (01) is inserted at the beginning of the data block (e.g., at the beginning of the sub-block for UE 101a), a second GI (GI2) is inserted between the two sub-blocks, and a third GI (GI3) is inserted at the end of the data block (e.g., at the end of the sub-block for UE 101b). This block structure is suitable for both DL or UL transmissions with a small packet/payload size, for low capability UEs 101 such as IoT UEs 101. For UL transmissions, a gap may or may not be added between two adjacent GIs (e.g., a fourth GI (GI4) of another data block (not shown by FIG. 4) after GI3). If the gap is inserted, the gap can be used to absorb the time synchronization (sync) error of the related UEs 101. Further, this sub-block structure can be used for the transmission of PUCCH format 0 or 1.

FIG. 5 illustrates an example sub-block structure 500 for a single carrier waveform according to a third time domain resource allocation embodiment. In this embodiment, separate GIs are inserted before and after each sub-block.

Although the embodiments shown and described with respect to FIGS. 3-5 only show two sub-blocks, the embodiments herein are not limited to dividing blocks into two sub-blocks. In various embodiments, individual blocks may be divided into more sub-blocks than shown by FIGS. 3-5.

In any of the aforementioned embodiments, the GIs, the GI embodiment to be used (e.g., as discussed with respect to FIGS. 3-5), the size of sub-blocks, or sets of sub-block sizes may be configured via higher layer signaling. For example, such a configuration may be signaled to the UEs 101 via NR minimum system information (MSI) signaling, NR remaining minimum system information (RMSI) signaling, NR other system information (OSI) signaling, radio resource control (RRC) signaling, medium access control-control element (MAC-CE) signaling, and/or dynamically indicated by DCI. For example, a set of the sub-block sizes may be configured via dedicated RRC signaling, and DCI may be signaled to the UE 101 to activate one sub-block size of the set of sub-block sizes to be used for reception of PDSCH and/or transmission of PUSCH. In such embodiments, a new or existing field in the DCI format may be used to indicate the sub-block size to be used from the set of the sub-block sizes.

In some embodiments, a time domain resource allocation can be defined at the block level, sub-block level, or according to time domain resource blocks (TRBs). Where TRBs are used, aspects of the TRBs can be predefined or configured via higher layers, for example, using MSI, RMSI, OSI, or RRC signaling. Additionally, the TRBs can be expressed in time units T_{c}=1/Δfₘₐₓ·N_{f} where Δfₘₐₓ is a maximum SCS where Δfₘₐₓ=1920·10³ Hz, and N_{f}=4096. In some embodiments, the TRB is defined in terms of the number of samples in the time domain based on a reference sampling rate, or in terms of the time unit T_{c} (see e.g., section 4.1 of 3GPP TS 38.211 v15.3.0 (2018-09) (hereinafter “TS 38.211”)).

FIG. 6 illustrates an example Time domain Resource Block (TRB) scheme 600 according to various embodiments. FIG. 6 shows N number of TRBs (labeled 0 to (N−1)) in one slot, where Nis a number. In this embodiment, the number of TRBs in a slot, N, can be determined based on the slot duration and/or the size of the TRBs. Additionally, a TRB can be assigned to either a GI or a UE's 101 data. In some embodiments, some of the TRBs including the first TRBs and/or the last TRBs may be used for the GI.

In one embodiment, a start and length indicator value (SLIV) can be employed for the time domain resource allocation for single carrier waveform for 52.6 GHz systems. For example, when the UE 101 is scheduled to receive PDSCH by downlink control information (DCI), the Time domain resource assignment field value m of the DCI provides a row index m+1 to an allocation table. The determination of the used resource allocation table is defined in subclause 5.1.2.1.1 of 3GPP TS 38.214 v15.2.0 (2018-06) (hereinafter “TS 38.214”). The indexed row defines the slot offset K₀, the start and length indicator SLIV, or directly the start symbol S and the allocation length L, and the PDSCH mapping type to be assumed in the PDSCH reception. Given the parameter values of the indexed row: the slot allocated for the PDSCH is

$$⌊ n \cdot \frac{{2}^{{μ}_{PDSCH}}}{{2}^{{μ}_{PDDCH}}} ⌋ + {K}_{0} ,$$

where n is the slot with the scheduling DCI, and K₀ is based on the numerology of PDSCH, and μ_{PDSCH} and μ_{PDDCH} are the SCS configurations for PDSCH and PDCCH, respectively, and the starting symbol S relative to the start of the slot, and the number of consecutive symbols L counting from the symbol S allocated for the PDSCH are determined from the start and length indicator SLIV: if (L−1)≤7 then SLIV=14·(L−1)+S; else SLIV=14·(14−L+1)+(14−1−S), where 0<L≤14−S, and the PDSCH mapping type is set to Type A or Type B as defined in Subclause 7.4.1.1.2 of TS 38.211.

In another example, when the UE 101 is scheduled to transmit a transport block and no CSI report, or the UE 101 is scheduled to transmit a transport block and a CSI report(s) on PUSCH by a DCI, the Time domain resource assignment field value m of the DCI provides a row index m+1 to an allocated table. The determination of the used resource allocation table is defined in subclause 6.1.2.1.1 of TS 38.214. The indexed row defines the slot offset K₂, the start and length indicator SLIV, or directly the start symbol S and the allocation length L, and the PUSCH mapping type to be applied in the PUSCH transmission. When the UE 101 is scheduled to transmit a PUSCH with no transport block and with a CSI report(s) by a CSI request field on a DCI, the Time-domain resource assignment field value m of the DCI provides a row index m+1 to an allocated table which is defined by the higher layer configured pusch-TimeDomainAllocationList in pusch-Config. The indexed row defines the start and length indicator SLIV, and the PUSCH mapping type to be applied in the PUSCH transmission and the K2 value is determined as

$${K}_{2} = \begin{matrix}max {Y}_{j} ( m + 1 ) \\ j\end{matrix} ,$$

where Yⱼ, j=0, . . . , N_{Rep}⁻¹ are the corresponding list entries of the higher layer parameter reportSlotOffsetList in CSI-ReportConfig for the N_{Rep} triggered CSI Reporting Settings and Yⱼ(m+1) is the (m+1)th entry of Yⱼ. The slot where the UE 101 shall transmit the PUSCH is determined by

$${K}_{2} as ⌊ n \cdot \frac{{2}^{{μ}_{PDSCH}}}{{2}^{{μ}_{PDDCH}}} ⌋ + {K}_{2}$$

where n is the slot with the scheduling DCI, K₂ is based on the numerology of PUSCH, and μ_{PUSCH} and μ_{PDCCH} are the SCS configurations for PUSCH and PDCCH, respectively, and the starting symbol S relative to the start of the slot, and the number of consecutive symbols L counting from the symbol S allocated for the PUSCH are determined from the start and length indicator SLIV of the indexed row: if (L−1)≤7 then SLIV=14·(L−1)+S; else SLIV=14·(14−L+1)+(14−1−S), where 0<L≤14−S, and the PUSCH mapping type is set to Type A or Type B as defined in Subclause 6.4.1.1.3 of TS 38.211 as given by the indexed row.

Further, in some embodiments, the granularity may be based on a TRB, a TRB Group (TBG), a sub-block, or a block instead of an OFDM symbol. Each TBG includes M TRBs, where M is a predefined number of TRBs or M is a configured number of TRBs indicated via by higher layers, such as the MSI, RMSI, OSI, or RRC signaling. In these embodiments, the start symbol S and the allocation length L of a data transmission (e.g., a PDSCH/PUS CH transmission) with their GIs can be indicated in terms of TRBs, TBGs, sub-block(s), or data block(s). Additionally or alternatively, the SLIV may be used to indicate the start symbol S and the allocation length L of a TRB including the one or more GIs.

In one example, the UE 101 determines the SLIV based on the DCI (or the time domain resource allocation field in the DCI), and from the SLIV, the UE 101 determines a start TRB (e.g., “TRBs”) and an allocation length L of the data transmission, where the allocation length L is a number of consecutive TRBs counting from the start TRBs. In this example, the start TRBs may be a starting or leading GI at the beginning of a data block (or sub-block), and a last TRB in the consecutive TRBs may be an ending GI for the data block (or sub-block).

In another example, the UE 101 determines the SLIV based on the DCI (or the time domain resource allocation field in the DCI), and from the SLIV, the UE 101 determines a start symbol S and an allocation length L of the data transmission, where the allocation length L is a number of consecutive symbols of one or more TRBs counting from the start symbol S. In this example, a first number of symbols starting with the start symbol S may be a starting or leading GI at the beginning of a data block (or sub-block), and one or more ending symbols in the consecutive symbols may be an ending GI for the data block (or sub-block).

In other embodiments, a bitmap based time domain resource allocation can be employed for single carrier waveform for 52.6 GHz systems. In such embodiments, the DL/UL resource allocation type 0 for frequency domain resource allocation can be straightforwardly extended and employed. In these embodiments, each bit in the bitmap represents a corresponding TRB, a corresponding TBG, a corresponding sub-block, or a corresponding data block in the time domain.

In one example, in DL resource allocation type 0, the RB assignment information includes a bitmap indicating the Resource Block Groups (RBGs) that are allocated to the scheduled UE 101 where a RBG is a set of consecutive VRBs defined by higher layer parameter rbg-Size configured by PDSCH-Config and the size of the BWP as defined in Table 5.1.2.2.1-1 of TS 38.214. Similarly, for UL resource allocation of type 0, the RB assignment information includes a bitmap indicating the RBGs that are allocated to the scheduled UE 101 where a RBG is a set of consecutive VRBs defined by higher layer parameter rbg-Size configured by pusch-Config and the size of the BWP as defined in Table 6.1.2.2.1-1 of TS 38.214. In this example for either DL or UL, one or more VRBs in the RBGs correspond(s) to a TRB, a TBG, a sub-block, or data block.

In another example, in DL resource allocation type 0, the RB assignment information includes a bitmap indicating the TBGs that are allocated to a scheduled UE 101 where a TBG is a set of consecutive TRBs defined by a suitable higher layer parameter (e.g., trb-Size) configured by a suitable configuration (e.g., PDSCH-Config and/or the like) and the size of a BWP. Similarly, for UL resource allocation type 0, the RB assignment information includes a bitmap indicating the TBGs that are allocated to a scheduled UE 101 where a TBG is a set of consecutive TRBs defined by a suitable higher layer parameter (e.g., trb-Size) configured by a suitable configuration (e.g., PUSCH-Config for PUSCH and/or the like) and the size of a BWP. In this example for either DL or UL, the TRBs may have a same or similar definition as defined for RBGs as shown by Table 5.1.2.2.1-1 and/or Table 6.1.2.2.1-1 of TS 38.214.

In another example, in DL resource allocation type 0, the RB assignment information includes a bitmap indicating the data blocks that are allocated to a scheduled UE 101 where a data block is a set of consecutive sub-blocks defined by a suitable higher layer parameter configured by a suitable configuration (e.g., PDSCH-Config for PDSCH and/or the like) and the size of a BWP. Similarly, for UL resource allocation type 0, the RB assignment information includes a bitmap indicating the data blocks that are allocated to a scheduled UE 101 where a data block is a set of consecutive sub-blocks defined by a suitable higher layer parameter configured by a suitable configuration (e.g., PUSCH-Config for PUSCH and/or the like) and the size of a BWP. In this example, the data blocks may have a same or similar definition as defined for RBGs as shown by Table 5.1.2.2.1-1 and/or Table 6.1.2.2.1-1 of TS 38.214.

In any of the aforementioned examples, the bitmap for UL and/or DL may be of size M_{TBG} bits with one bitmap bit per TBG such that each TBG is addressable. In some embodiments, the TBGs may be indexed in the order of increasing frequency and starting at the lowest frequency of the BWP. In these embodiments, the order of the TBG bitmap is such that TBG 0 to TBG M_{TBG}−1 are mapped from MSB to LSB, and the TBG is allocated to the UE 101 if the corresponding bit value in the bitmap is 1, the TBG is not allocated to the UE 101 otherwise.

### Frequency Time Domain Resource Allocation for 52.6 GHz Systems

FIG. 7 illustrates an example 700 of configured BWPs within system BW, according to various embodiments. In NR systems, BWPs allow limited capability UEs 101 to access the network. Limited capability UEs 101 may refer to low complexity devices (e.g., IoT UEs 101) and/or UEs 101 with limited radio frequency (RF) BW. A BWP includes a group of contiguous PRBs. As shown by FIG. 7, the BW of a BWP is equal to, or is smaller than each UE's 101 maximum BW capability, and is at least as large as synchronization signal block (SSB) BW. Further, one BWP is configured with a numerology including an SCS and CP.

A UE 101 can be configured with up to four DL BWPs with a single DL BWP being active at a given time for a cell or carrier, and a UE 101 can be configured with up to four UL BWPs with a single uplink BWP active at a given time for a cell or carrier. The UE 101 is not expected to receive PDSCH, PDCCH, or CSI-RS (except for RRM) outside an active BWP, and the UE 101 does not transmit PUSCH or PUCCH outside an active BWP. The UE 101 may receive the PDCCH within a narrower BWP in order to reduce power consumption. Subsequently, the UE 101 may switch to a BWP with a larger BW such as when a high data rate transmission has been scheduled. By employing BWP switching, UE 101 power consumption can be reduced.

The UE 101 determines the frequency domain RB assignment using the resource allocation field (e.g., frequency domain resource assignment field) in a detected DCI carried by PDCCH except for PUSCH transmissions scheduled by a Random Access Response (RAR) UL grant, in which case the frequency domain resource allocation is determined according to subclause 8.3 of 3GPP TS 38.213 v15.3.0 (2018-09) (hereinafter “TS 38.213”). As an example, the detected DCI may be DCI format 1_0 or DCI format 1_1 as discussed by sections 7.3.1.2.1 and 7.3.1.2.2 of TS 38.212, respectively.

As alluded to previously, there are two DL and UL resource allocation schemes, type 0 and type 1. The UE 101 assumes that when the scheduling grant is received with DCI format 1_0, then the DL resource allocation type 1 is used. If the scheduling DCI is configured to indicate the DL resource allocation type as part of the Frequency domain resource assignment field by setting a higher layer parameter resourceAllocation in pdsch-Config to ‘dynamicswitch’, the UE 101 uses DL resource allocation type 0 or type 1 as defined by the Frequency domain resource assignment field in the DCI. Otherwise, the UE 101 uses the DL frequency resource allocation type as defined by the higher layer parameter resourceAllocation.

For UL resource allocation schemes, UL resource allocation scheme type 0 is supported for PUSCH only when transform precoding is disabled, and type 1 is supported for PUSCH for both cases when transform precoding is enabled or disabled. If the scheduling DCI is configured to indicate the UL resource allocation type as part of the Frequency domain resource assignment field by setting a higher layer parameter resourceAllocation in pusch-Config to ‘dynamicSwitch’, the UE 101 uses uplink resource allocation type 0 or type 1 as defined by the Frequency domain resource assignment field in the DCI. Otherwise, the UE 101 uses the uplink frequency resource allocation type as defined by the higher layer parameter resourceAllocation. The UE shall assume that when the scheduling PDCCH is received with DCI format 0_0, then uplink resource allocation type 1 is used.

If a bandwidth part indicator field is not configured in the scheduling DCI or the UE 101 does not support active BWP change via DCI, the RB indexing for DL or UL type 0 and type 1 resource allocation is determined within the UE's 101 active BWP. If a bandwidth part indicator field is configured in the scheduling DCI and the UE 101 supports active BWP change via DCI, the RB indexing for DL or UL type 0 and type 1 resource allocation is determined within the UE's 101 BWP indicated by the bandwidth part indicator field value in the DCI. Upon detection of PDCCH intended for the UE 101, the UE 101 first determines the DL bandwidth part and then determines the resource allocation within the BWP. At least for the UL, RB numbering starts from the lowest RB in the determined UL BWP.

For DL and UL resource allocation type 0, the RB assignment information includes a bitmap indicating the RBGs that are allocated to the scheduled UE 101 where an RBG is a set of consecutive VRBs defined by higher layer parameter rbg-Size configured by PDSCH-Config for the DL or configured by pusch-Config for the UL, and the size of the BWP as defined in Table 5.1.2.2.1-1 of TS 38.214 for DL or defined in Table 6.1.2.2.1-1 of TS 38.214 for UL. For DL and UL resource allocation type 1, the RB assignment information indicates to the scheduled UE 101 a set of contiguously allocated non-interleaved or interleaved VRBs within the active BWP of size N_{BWP}^{size} PRBs.

For 52.6 GHz systems, a BWP can be supported to allow limited capability UEs 101 to access the network, and to reduce UE 101 power consumption. However, for single carrier waveform (e.g., SC-FDE waveforms), the frequency domain resource allocation in terms of PRBs may not be needed. In this case, to allow multiple UEs 101 to access the network simultaneously, frequency domain resource allocation embodiments for single carrier waveform transmission schemes (e.g., SC-FDE waveform) in 52.6 GHz systems are as follows:

In one frequency domain resource allocation embodiment, the UE 101 can be configured with multiple BWPs, where one BWP in the DL and/or one BWP in the UL can be active for a given time in a component cell (CC) (or component carrier (CC)). The physical channels and signals fully occupy the active BWP. In this embodiment, a frequency domain resource assignment field for specific PBRs in the DCI used to dynamically schedule PDSCH and/or PUSCH may not be needed, and as such, these PRB-related fields may be removed or omitted from the DCI. For example, the VRB-to-PRB mapping field, a PRB bundling size field, and/or a frequency hopping field may be removed or omitted from the DCI. Further, for configured grant PUSCH transmissions, the parameters related to frequency resource allocation such as resourceAllocation, rbg-Size, frequencyDomainAllocation, frequencyHoppingOffset, and frequencyHopping may not be needed in the RRC configuration message.

In another embodiment, the UE 101 may be configured with multiple BWPs, where one BWP in DL and/or UL can be activated in a CC for one or more UE 101 antenna port groups. In this embodiment, each antenna port group corresponds to a transmission or reception panel. This embodiment may also be applied to carriers below 52.6 GHz and/or other waveforms (e.g., CP-OFDM and DFT-s-OFDM) as well as 52.6 GHz systems and single carrier waveform (e.g., SC-FDE waveforms).

In another embodiment, the BW of a BWP can be a fraction of the system BW. For example, the BW of a BWP can be defined as:

$$B {W}_{BWP} = \frac{B {W}_{Sys}}{K}$$

In the above equation, BW_{BWP} is the BW of a BWP, BW_{Sys} is the system BW and K is an integer. In one example, K=2ⁿ, where n is an integer.

To indicate the location of a BWP for a given UE 101, point A can be defined and employed for single carrier waveform for 52.6 GHz systems. Further, the starting location of the configured BWP can be defined as an absolution frequency distance (e.g., in MHz) relative to point A. To reduce the signaling overhead, the value K as mentioned previously can be indicated/signaled to the UE 101 in the DCI and/or in a high layer configuration. In this embodiment, the UE 101 determines the BW of the BWP based on the indicated K value.

### Example Systems and Implementations

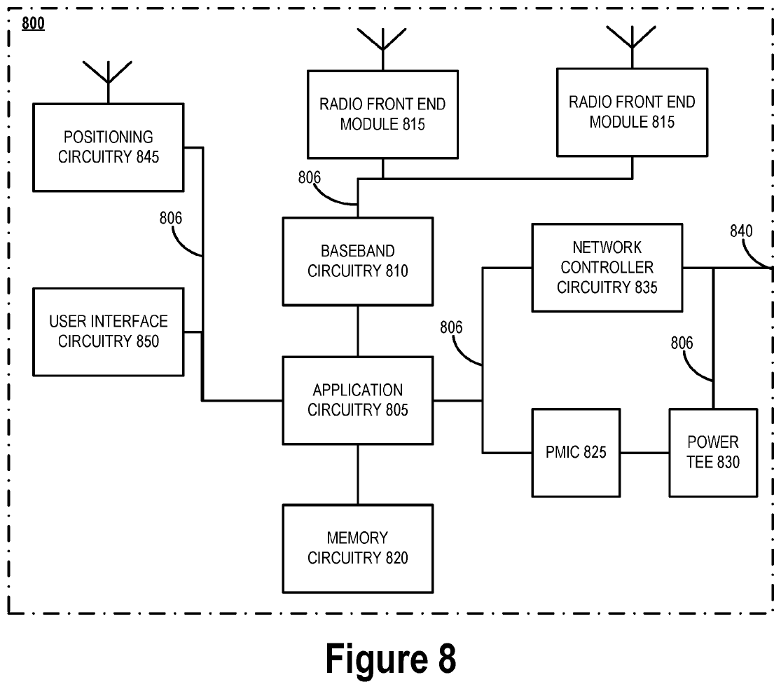

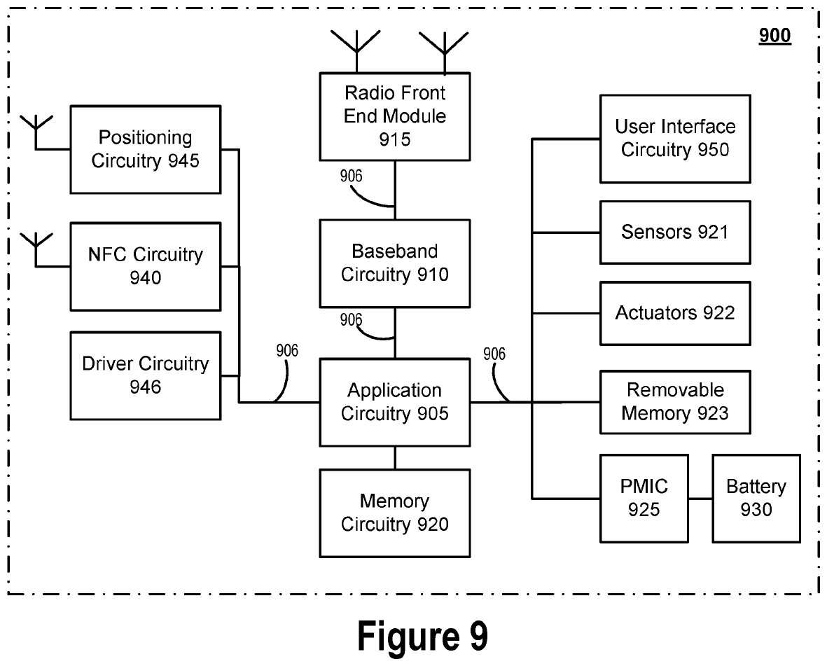

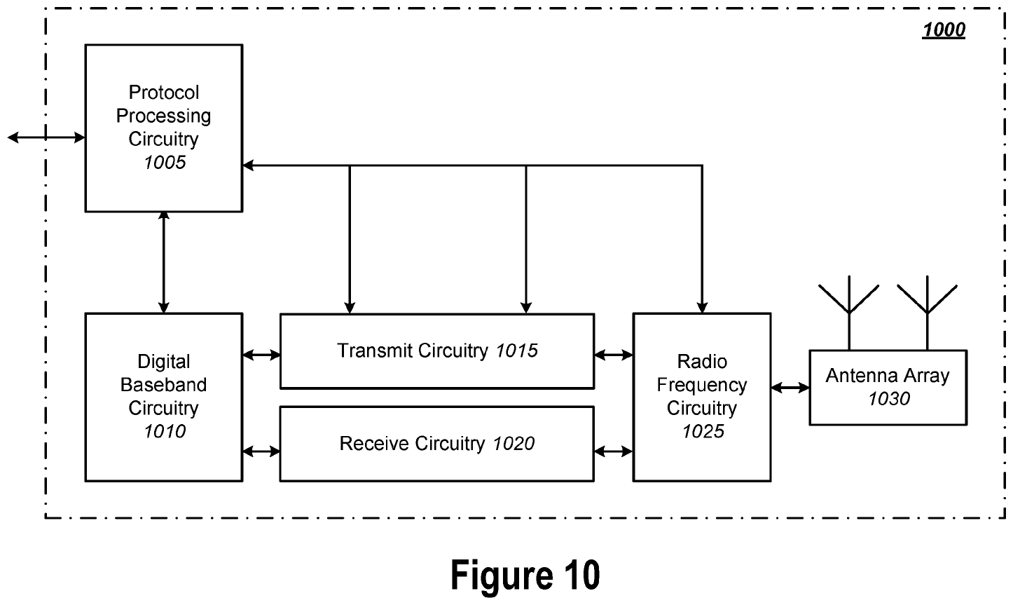

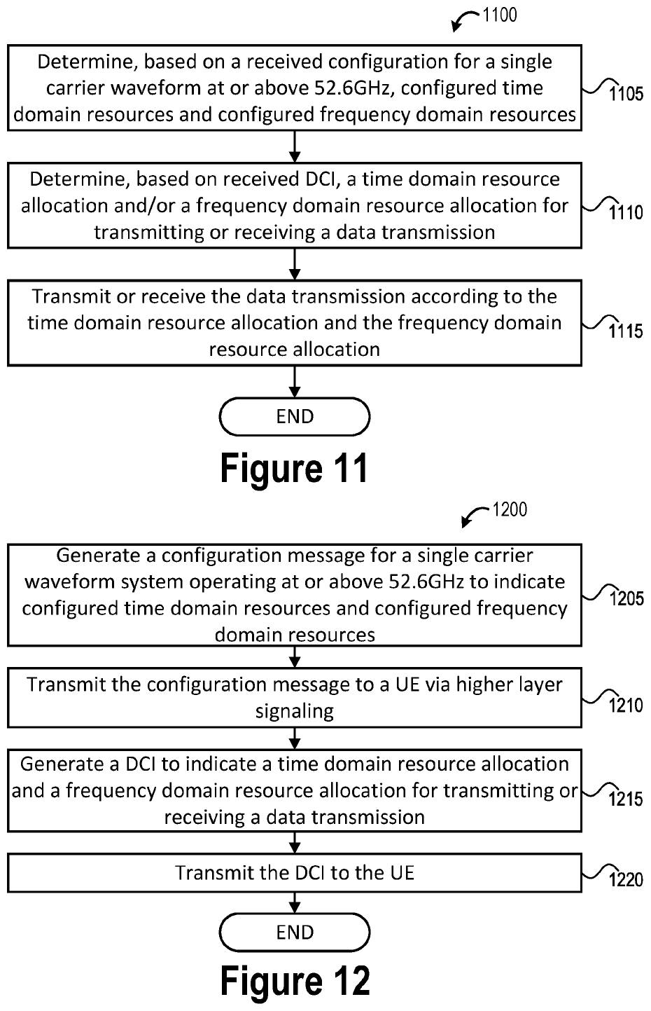

Each of the UEs 101, RAN nodes 111, AP 106, network element(s) 122, application servers 130, and/or any other device or system discussed previously with respect to FIGS. 1-7 may include various hardware and/or software elements, such as those discussed infra with respect to FIG. 8 and XS2.

FIG. 8 illustrates an example of infrastructure equipment 800 in accordance with various embodiments. The infrastructure equipment 800 (or “system 800”) may be implemented as a base station, radio head, RAN node such as the RAN nodes 111 and/or AP 106 shown and described previously, application server(s) 130, and/or any other element/device discussed herein. In other examples, the system 800 could be implemented in or by a UE.

The system 800 includes application circuitry 805, baseband circuitry 810, one or more radio front end modules (RFEMs) 815, memory circuitry 820, power management integrated circuitry (PMIC) 825, power tee circuitry 830, network controller circuitry 835, network interface connector 840, satellite positioning circuitry 845, and user interface 850. In some embodiments, the device 800 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations. The term “circuitry” as used herein refers to a circuit or system of multiple circuits configured to perform a particular function in an electronic device. The circuit or system of circuits may be part of, or include one or more hardware components, such as logic circuits, processor(s) (shared, dedicated, or group) and/or memory (shared, dedicated, or group), Integrated Circuits (ICs), Application-specific ICs (ASICs), Field Programmable Gate Arrays (FPGAs), Digital Signal Processors (DSPs), etc., that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry. The term “processor circuitry” as used herein refers to, is part of, or includes circuitry capable of sequentially and automatically carrying out a sequence of arithmetic or logical operations, or recording, storing, and/or transferring digital data. and/or any other device capable of executing or otherwise operating computer-executable instructions, such as program code, software modules, and/or functional processes. As used herein, the term “module” refers to one or more independent electronic circuits packaged onto a circuit board, FPGA, ASIC, SoC, SiP, etc., configured to provide a basic function within a computer system. A “module” may include a processor circuitry (shared, dedicated, or group) and/or memory circuitry shared, dedicated, or group), etc., that execute one or more software or firmware programs, a combinational logic circuit, and/or other suitable components that provide the described functionality. As used herein, the term “interface circuitry” refers to, is part of, or includes circuitry providing for the exchange of information between two or more components or devices. The term “interface circuitry” refers to one or more hardware interfaces, for example, buses, input/output (I/O) interfaces, peripheral component interfaces, network interface cards, and/or the like.

Application circuitry 805 includes circuitry such as, but not limited to one or more processors (or processor cores), cache memory, and one or more of low drop-out voltage regulators (LDOs), interrupt controllers, serial interfaces such as SPI, I²C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 805 may be coupled with or may include memory/storage elements and may be configured to execute instructions stored in the memory/storage to enable various applications or operating systems to run on the system 800. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 805 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 805 may comprise, or may be, a special-purpose processor/controller to operate according to the various embodiments herein. As examples, the processor(s) of application circuitry 805 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 800 may not utilize application circuitry 805, and instead may include a special-purpose processor/controller to process IP data received from an EPC or 5GC, for example.

In some implementations, the application circuitry 805 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 805 may comprise logic blocks or logic fabric, and other interconnected resources that may be programmed to perform various functions, such as the procedures, methods, functions, etc. of the various embodiments discussed herein. In such embodiments, the circuitry of application circuitry 805 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

The baseband circuitry 810 may be implemented, for example, as a solder-down substrate including one or more integrated circuits, a single packaged integrated circuit soldered to a main circuit board or a multi-chip module containing two or more integrated circuits. The baseband circuitry 810 includes one or more processing devices (e.g., baseband processors) to carry out various protocol and radio control functions. Baseband circuitry 810 may interface with application circuitry of system 800 for generation and processing of baseband signals and for controlling operations of the RFEMs 815. The baseband circuitry 810 may handle various radio control functions that enable communication with one or more radio networks via the RFEMs 815. The baseband circuitry 810 may include circuitry such as, but not limited to, one or more single-core or multi-core processors (e.g., one or more baseband processors) or control logic to process baseband signals received from a receive signal path of the RFEMs 815, and to generate baseband signals to be provided to the RFEMs 815 via a transmit signal path. In various embodiments, the baseband circuitry 810 may implement a RTOS to manage resources of the baseband circuitry 810, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein.

User interface circuitry 850 may include one or more user interfaces designed to enable user interaction with the system 800 or peripheral component interfaces designed to enable peripheral component interaction with the system 800. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 815 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays, and the RFEM may be connected to multiple antennas. In alternative implementations, both mmWave and sub-mmWave radio functions may be implemented in the same physical RFEM 815, which incorporates both mmWave antennas and sub-mmWave.

The memory circuitry 820 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 820 may be implemented as one or more of solder down packaged integrated circuits, socketed memory modules and plug-in memory cards.

The PMIC 825 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 830 may provide for electrical power drawn from a network cable to provide both power supply and data connectivity to the infrastructure equipment 800 using a single cable.

The network controller circuitry 835 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 800 via network interface connector 840 using a physical connection, which may be electrical (commonly referred to as a “copper interconnect”), optical, or wireless. The network controller circuitry 835 may include one or more dedicated processors and/or FPGAs to communicate using one or more of the aforementioned protocols. In some implementations, the network controller circuitry 835 may include multiple controllers to provide connectivity to other networks using the same or different protocols.

The positioning circuitry 845 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 845 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 845 may include a Micro-Technology for Positioning, Navigation, and Timing (Micro-PNT) IC that uses a master timing clock to perform position tracking/estimation without GNSS assistance. The positioning circuitry 845 may also be part of, or interact with, the baseband circuitry 810 and/or RFEMs 815 to communicate with the nodes and components of the positioning network. The positioning circuitry 845 may also provide position data and/or time data to the application circuitry 805, which may use the data to synchronize operations with various infrastructure (e.g., RAN nodes 111, etc.), or the like.

The components shown by FIG. 8 may communicate with one another using interface circuitry 806 or IX 806, which may include any number of bus and/or IX technologies such as Industry Standard Architecture (ISA), extended ISA, inter-integrated circuit (I²C), Serial Peripheral Interface (SPI), point-to-point interfaces, power management bus (PMBus), Peripheral Component Interconnect (PCI), PCI express (PCIe), PCI extended (PCIx), Intel® Ultra Path Interconnect (UPI), Intel® Accelerator Link (IAL), Coherent Accelerator Processor Interface (CAPI), OpenCAPI™, Intel® QuickPath Interconnect (QPI), Intel® Omni-Path Architecture (OPA) IX, RapidIO™ system IXs, Cache Coherent Interconnect for Accelerators (CCIX), Gen-Z Consortium IXs, a HyperTransport IX, NVLink provided by NVIDIA®, and/or any number of other IX technologies. Additionally or alternatively, the IX technology may be a proprietary bus, for example, used in an SoC based system.

FIG. 9 illustrates an example of a platform 900 (or “device 900”) in accordance with various embodiments. In embodiments, the computer platform 900 may be suitable for use as UEs 101, application servers 130, and/or any other element/device discussed herein. The platform 900 may include any combinations of the components shown in the example. The components of platform 900 may be implemented as integrated circuits (ICs), portions thereof, discrete electronic devices, or other modules, logic, hardware, software, firmware, or a combination thereof adapted in the computer platform 900, or as components otherwise incorporated within a chassis of a larger system. Some of the components shown may be omitted, additional components may be present, and different arrangement of the components shown may occur in other implementations.

Application circuitry 905 includes circuitry such as, but not limited to one or more processors (or processor cores), cache memory, and one or more of LDOs, interrupt controllers, serial interfaces such as SPI, I²C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 905 may be coupled with or may include memory/storage elements and may be configured to execute instructions stored in the memory/storage to enable various applications or operating systems to run on the system 900. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 805 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 805 may comprise, or may be, a special-purpose processor/controller to operate according to the various embodiments herein.

As examples, the processor(s) of application circuitry 905 may include an Intel® Architecture Core™ based processor, such as a Quark™, an Atom™, an i3, an i5, an i7, or an MCU-class processor, or another such processor available from Intel® Corporation, Santa Clara, Calif. The processors of the application circuitry 905 may also be one or more of Advanced Micro Devices (AMD) Ryzen® processor(s) or Accelerated Processing Units (APUs); A5-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 905 may be a part of a system on a chip (SoC) in which the application circuitry 905 and other components are formed into a single integrated circuit, or a single package, such as the Edison™ or Galileo™ SoC boards from Intel® Corporation.

Additionally or alternatively, application circuitry 905 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 905 may comprise logic blocks or logic fabric, and other interconnected resources that may be programmed to perform various functions, such as the procedures, methods, functions, etc. of the various embodiments discussed herein. In such embodiments, the circuitry of application circuitry 905 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 910 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 910 are discussed infra with regard to Figure XT.

The RFEMs 915 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array XT111 of Figure XT infra), and the RFEM may be connected to multiple antennas. In alternative implementations, both mmWave and sub-mmWave radio functions may be implemented in the same physical RFEM 915, which incorporates both mmWave antennas and sub-mmWave.

The memory circuitry 920 may include any number and type of memory devices used to provide for a given amount of system memory. As examples, the memory circuitry 920 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry 920 may be developed in accordance with a Joint Electron Devices Engineering Council (JEDEC) low power double data rate (LPDDR)-based design, such as LPDDR2, LPDDR3, LPDDR4, or the like. Memory circuitry 920 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 920 may be on-die memory or registers associated with the application circuitry 905. To provide for persistent storage of information such as data, applications, operating systems and so forth, memory circuitry 920 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 900 may incorporate the three-dimensional (3D) cross-point (XPOINT) memories from Intel® and Micron®.

Removable memory circuitry 923 may include devices, circuitry, enclosures/housings, ports or receptacles, etc. used to couple portable data storage devices with the platform 900. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 900 may also include interface circuitry (not shown) that is used to connect external devices with the platform 900. The external devices connected to the platform 900 via the interface circuitry include sensor circuitry 921 and electro-mechanical components (EMCs) 922, as well as removable memory devices coupled to removable memory circuitry 923.

The sensor circuitry 921 include devices, modules, or subsystems whose purpose is to detect events or changes in its environment and send the information (sensor data) about the detected events to some other a device, module, subsystem, etc. Examples of such sensors include, inter alia, inertia measurement units (IMUs) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

The actuators 922, allow platform 900 to change its state, position, and/or orientation, or move or control a mechanism or system. The actuators 922 comprise electrical and/or mechanical devices for moving or controlling a mechanism or system, and converts energy (e.g., electric current or moving air and/or liquid) into some kind of motion. The actuators 922 may include one or more electronic (or electrochemical) devices, such as piezoelectric biomorphs, solid state actuators, solid state relays (SSRs), shape-memory alloy-based actuators, electroactive polymer-based actuators, relay driver integrated circuits (ICs), and/or the like. The actuators 922 may include one or more electromechanical devices such as pneumatic actuators, hydraulic actuators, electromechanical switches including electromechanical relays (EMRs), motors (e.g., DC motors, stepper motors, servomechanisms, etc.), wheels, thrusters, propellers, claws, clamps, hooks, an audible sound generator, and/or other like electromechanical components. The platform 900 may be configured to operate one or more actuators 922 based on one or more captured events and/or instructions or control signals received from a service provider and/or various client systems.

In some implementations, the interface circuitry may connect the platform 900 with positioning circuitry 945. The positioning circuitry 945 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 945 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 945 may include a Micro-PNT IC that uses a master timing clock to perform position tracking/estimation without GNSS assistance. The positioning circuitry 945 may also be part of, or interact with, the baseband circuitry 810 and/or RFEMs 915 to communicate with the nodes and components of the positioning network. The positioning circuitry 945 may also provide position data and/or time data to the application circuitry 905, which may use the data to synchronize operations with various infrastructure (e.g., radio base stations), for turn-by-turn navigation applications, or the like

In some implementations, the interface circuitry may connect the platform 900 with Near-Field Communication (NFC) circuitry 940. NFC circuitry 940 is configured to provide contactless, short-range communications based on radio frequency identification (RFID) standards, wherein magnetic field induction is used to enable communication between NFC circuitry 940 and NFC-enabled devices external to the platform 900 (e.g., an “NFC touchpoint”). NFC circuitry 940 comprises an NFC controller coupled with an antenna element and a processor coupled with the NFC controller. The NFC controller may be a chip/IC providing NFC functionalities to the NFC circuitry 940 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 940, or initiate data transfer between the NFC circuitry 940 and another active NFC device (e.g., a smartphone or an NFC-enabled POS terminal) that is proximate to the platform 900.

The driver circuitry 946 may include software and hardware elements that operate to control particular devices that are embedded in the platform 900, attached to the platform 900, or otherwise communicatively coupled with the platform 900. The driver circuitry 946 may include individual drivers allowing other components of the platform 900 to interact with or control various input/output (I/O) devices that may be present within, or connected to, the platform 900. For example, driver circuitry 946 may include a display driver to control and allow access to a display device, a touchscreen driver to control and allow access to a touchscreen interface of the platform 900, sensor drivers to obtain sensor readings of sensor circuitry 921 and control and allow access to sensor circuitry 921, EMC drivers to obtain actuator positions of the EMCs 922 and/or control and allow access to the EMCs 922, a camera driver to control and allow access to an embedded image capture device, audio drivers to control and allow access to one or more audio devices.

The power management integrated circuitry (PMIC) 925 (also referred to as “power management circuitry 925”) may manage power provided to various components of the platform 900. In particular, with respect to the baseband circuitry 910, the PMIC 925 may control power-source selection, voltage scaling, battery charging, or DC-to-DC conversion. The PMIC 925 may often be included when the platform 900 is capable of being powered by a battery 930, for example, when the device is included in a UE 101.

In some embodiments, the PMIC 925 may control, or otherwise be part of, various power saving mechanisms of the platform 900. For example, if the platform 900 is in an RRC_Connected state, where it is still connected to the RAN node as it expects to receive traffic shortly, then it may enter a state known as Discontinuous Reception Mode (DRX) after a period of inactivity. During this state, the platform 900 may power down for brief intervals of time and thus save power. If there is no data traffic activity for an extended period of time, then the platform 900 may transition off to an RRC_Idle state, where it disconnects from the network and does not perform operations such as channel quality feedback, handover, etc. The platform 900 goes into a very low power state and it performs paging where again it periodically wakes up to listen to the network and then powers down again. The platform 900 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 930 may power the platform 900, although in some examples the platform 900 may be mounted deployed in a fixed location, and may have a power supply coupled to an electrical grid. The battery 930 may be a lithium ion battery, a metal-air battery, such as a zinc-air battery, an aluminum-air battery, a lithium-air battery, and the like. In some implementations, such as in V2X applications, the battery 930 may be a typical lead-acid automotive battery.

In some implementations, the battery 930 may be a “smart battery,” which includes or is coupled with a Battery Management System (BMS) or battery monitoring integrated circuitry. The BMS may be included in the platform 900 to track the state of charge (SoCh) of the battery 930. The BMS may be used to monitor other parameters of the battery 930 to provide failure predictions, such as the state of health (SoH) and the state of function (SoF) of the battery 930. The BMS may communicate the information of the battery 930 to the application circuitry 905 or other components of the platform 900. The BMS may also include an analog-to-digital (ADC) convertor that allows the application circuitry 905 to directly monitor the voltage of the battery 930 or the current flow from the battery 930. The battery parameters may be used to determine actions that the platform 900 may perform, such as transmission frequency, network operation, sensing frequency, and the like.

A power block, or other power supply coupled to an electrical grid may be coupled with the BMS to charge the battery 930. In some examples, the power block XS30 may be replaced with a wireless power receiver to obtain the power wirelessly, for example, through a loop antenna in the computer platform 900. In these examples, a wireless battery charging circuit may be included in the BMS. The specific charging circuits chosen may depend on the size of the battery 930, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 950 includes various input/output (I/O) devices present within, or connected to, the platform 900, and includes one or more user interfaces designed to enable user interaction with the platform 900 and/or peripheral component interfaces designed to enable peripheral component interaction with the platform 900. The user interface circuitry 950 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 900. The output device circuitry may also include speakers or other audio emitting devices, printer(s), and/or the like. In some embodiments, the sensor circuitry 921 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

The components shown by FIG. 9 may communicate with one another using interface circuitry 906 or IX 906, which may include any number of bus and/or IX technologies such as ISA, extended ISA, I²C, SPI, point-to-point interfaces, PMBus, PCI, PCIe, PCIx, Intel® UPI, Intel® IAL, Intel® CXL, CAPI, OpenCAPI, Intel® QPI, Intel® UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, and/or any number of other IX technologies. Additionally or alternatively, the IX technology may be a proprietary bus, for example, used in an SoC based system.

FIG. 10 illustrates an example of communication circuitry 1000 that may be used to practice the embodiments discussed herein. Components as shown by FIG. 10 are shown for illustrative purposes and may include other components not shown by FIG. 10, or the elements shown by FIG. 10 may by alternatively be grouped according to functions.

The communication circuitry 1000 includes protocol processing circuitry 1005, which operates or implements various protocol layers/entities of one or more wireless communication protocols. In one example, the protocol processing circuitry 1005 may operate Long Term Evolution (LTE) protocol entities and/or Fifth Generation (5G)/New Radio (NR) protocol entities when the communication circuitry 1000 is a cellular radiofrequency communication system, such as millimeter wave (mmWave) communication circuitry or some other suitable cellular communication circuitry. In this example, the protocol processing circuitry 1005 would operate medium access control (MAC), radio link control (RLC), packet data convergence protocol (PDCP), service data adaptation protocol (SDAP), radio resource control (RRC), and non-access stratum (NAS) functions. In another example, the protocol processing circuitry 1005 may operate one or more IEEE-based protocols when the communication circuitry 1000 is WiFi communication system. In this example, the protocol processing circuitry 1005 would operate MAC and logical link control (LLC) functions.

The protocol processing circuitry 1005 may include one or more memory structures (not shown) to store program code and data information for operating the protocol functions, as well as one or more processing cores (not shown) to execute the program code and perform various operations using the data information. The protocol processing circuitry 1005 may include one or more instances of control circuitry (not shown) to provide control functions for the digital baseband circuitry 1010, transmit circuitry 1015, receive circuitry 1020, and/or radiofrequency (RF) circuitry 1025. In some embodiments, the protocol processing circuitry 1005 and/or the baseband circuitry 1010 correspond to the baseband circuitry 810 and 910 of FIGS. 8 and 9, respectively.

The communication circuitry 1000 also includes digital baseband circuitry 1010, which implements physical layer (PHY) functions including hybrid automatic repeat request (HARQ) functions, scrambling and/or descrambling, (en)coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, radio frequency shifting, and other related functions. The modulation/demodulation functionality may include Fast-Fourier Transform (FFT), precoding, or constellation mapping/demapping functionality. The encoding/decoding functionality may include convolution, tail-biting convolution, turbo, Viterbi, Low Density Parity Check (LDPC) coding, polar coding, etc. Embodiments of modulation/demodulation and encoder/decoder functionality are not limited to these examples and may include other suitable functionality in other embodiments.

Baseband processing circuitry 1010 and/or protocol processing circuitry 1005 may interface with an application platform (e.g., application circuitry 805 or application circuitry 905 of FIGS. 8 and 9, respectively) for generation and processing of baseband signals and for controlling operations of the RF circuitry 1025. The digital baseband circuitry 1010 may handle various radio control functions that enable communication with one or more radio networks via the RF circuitry 1025. The digital baseband circuitry 1010 may include circuitry such as, but not limited to, one or more single-core or multi-core processors (e.g., one or more baseband processors) or control logic to process baseband signals received from a receive signal path of the RF circuitry 1025 (e.g., via Rx circuitry 1020) and to generate baseband signals for a transmit signal path of the RF circuitry 1025 (e.g., via Tx circuitry 1015). The digital baseband circuitry 1010 may comprise a multi-protocol baseband processor or the like.

As mentioned previously, the digital baseband circuitry 1010 may include or implement encoder circuitry, which accepts input data, generates encoded data based on the input data, and outputs the encoded data to a modulation mapper. The encoder may also perform one or more of error detecting, error correcting, rate matching, and interleaving. The encoder may further include scrambling based on a scrambling sequence such as those discussed herein. The digital baseband circuitry 1010 may include or implement a sequence generator to generate, for example, low Peak to Average Power Ratio (low-PAPR) sequences (see e.g., section 5.2.2 of TS 38.211), pseudo-random noise (PN) sequences (see e.g., section 5.2.1 of TS 38.211), and/or reference signal sequences. In some embodiments, the sequence generator may be a part of the encoder circuitry.

The digital baseband circuitry 1010 may include or implement a modulation mapper that takes binary digits as input (e.g., the encoded data from the encoder) and produces complex-valued modulation symbols as an output. The modulation mapper may operate one or more suitable modulation schemes, such as those discussed by, for example, section 5.1 of TS 38.211. The modulation mapper may map groups containing one or more binary digits, selected from the encoded data, to complex valued modulation symbols according to one or more mapping tables. The complex-valued modulation symbols may be input to a layer mapper to be mapped to one or more layer mapped modulation symbol streams (see e.g., sections 6.3.1.3 and 7.3.1.3 of TS 38.211). The one or more streams of layer mapped symbols may be input to precoder that generates one or more streams of precoded symbols, which may be represented as a block of vectors. The precoder may be configured to perform a direct mapping using a single antenna port, transmit diversity using space-time block coding, or spatial multiplexing. Each stream of precoded symbols may be input to a resource mapper that generates a stream of resource mapped symbols (e.g., REs). The resource mapper may map precoded symbols to frequency domain subcarriers and time domain symbols according to a mapping, which may include contiguous block mapping, randomized mapping, and/or sparse mapping according to a mapping code.

The digital baseband circuitry 1010 may also include or implement a baseband signal generator (also referred to as a “multicarrier generator”) to generate OFDM baseband signals and/or other baseband signals. In these embodiments, the resource mapped symbols from the resource mapper are input to the baseband signal generator which generates time domain baseband symbol(s). The baseband signal generator may generate a time domain signal (e.g., a set of time domain symbols) using, for example, an inverse discrete Fourier transform, commonly implemented as an inverse fast Fourier transform (IFFT) or a filter bank comprising one or more filters. The time-domain signal that results from the IFFT is transmitted across the radio channel. At the receiver, an FFT block is used to process the received signal and bring it into the frequency domain which is used to recover the original data bits. Other/additional aspects of the operation of the digital baseband circuitry 1010 are discussed by TS 38.211.

The communication circuitry 1000 also includes transmit (Tx) circuitry 1015 and receive (Rx) circuitry 1020. The Tx circuitry 1015 is configured to convert digital baseband signals into analog signals for transmission by the RF circuitry 1025. To do so, in one embodiment, the Tx circuitry 1015 includes various components, such as digital to analog converters (DACs), analog baseband circuitry, up-conversion circuitry, and filtering and amplification circuitry. Additionally or alternatively, the Tx circuitry 1015 may include digital transmit circuitry and output circuitry.

The Rx circuitry 1020 is configured to convert analog signals received by the RF circuitry 1025 into digital baseband signals to be provided to the digital baseband circuitry 1010. To do so, in one embodiment, the Rx circuitry 1020 includes parallel receive circuitry and/or one or more instances of combined receive circuitry. The parallel receive circuitry and instances of the combined receive circuitry may include Intermediate Frequency (IF) down-conversion circuitry, IF processing circuitry, baseband down-conversion circuitry, baseband processing circuitry, and analog-to-digital converter (ADC) circuitry.

The communication circuitry 1000 also includes radiofrequency (RF) circuitry 1025 to enable communication with wireless networks using modulated electromagnetic radiation through a non-solid medium. The RF circuitry 1025 includes a receive signal path, which may include circuitry to convert analog RF signals (e.g., an existing or received modulated waveform) into digital baseband signals to be provided to the digital baseband circuitry 1010 via the Rx circuitry 1020. The RF circuitry 1025 also includes a transmit signal path, which may include circuitry configured to convert digital baseband signals provided by the digital baseband circuitry 1010 via the Tx circuitry 1015 to be converted into analog RF signals (e.g., modulated waveform) that will be amplified and transmitted via the antenna array 1030.

RF circuitry 1025 may include one or more instances of radio chain circuitry, which may include one or more filters, power amplifiers, low noise amplifiers, programmable phase shifters, and power supplies (not shown). RF circuitry 1025 may also include power combining and dividing circuitry. The power combining and dividing circuitry may operate bidirectionally, such that the same physical circuitry may be configured to operate as a power divider when the device is transmitting, and as a power combiner when the device is receiving. In some embodiments, the power combining and dividing circuitry may include wholly or partially separate circuitries to perform power dividing when the device is transmitting and power combining when the device is receiving. The power combining and dividing circuitry may include passive circuitry comprising one or more two-way power divider/combiners arranged in a tree. In some embodiments, the power combining and dividing circuitry may include active circuitry comprising amplifier circuits.

The communication circuitry 1000 also includes antenna array 1030. The antenna array 1030 include one or more antenna elements. The antenna array 1030 may be a plurality of microstrip antennas or printed antennas that are fabricated on the surface of one or more printed circuit boards. The antenna array 1030 may be formed in as a patch of metal foil (e.g., a patch antenna) in a variety of shapes, and may be coupled with the RF circuitry 1025 using metal transmission lines or the like.

FIGS. 11 and 12 show example procedures 1100 and 1200, respectively, in accordance with various embodiments. For illustrative purposes, the various operations of process 1100 is described as being performed by a UE 101 or elements thereof, and process 1200 is described as being performed by a RAN node 111. In some embodiments, the processes 1100 and 1200 may be embodied as one or more computer readable storage media comprising program code, instructions, or other like a computer program product (or data to create the computer program product), which is to cause a computing device (e.g., UE 101 or RAN node 111) to perform electronic operations and/or to perform the specific sequence or flow of actions described with respect to FIGS. 11 and 12. While particular examples and orders of operations are illustrated FIGS. 11 and 12, the depicted orders of operations should not be construed to limit the scope of the embodiments in any way. Rather, the depicted operations may be re-ordered, broken into additional operations, combined, and/or omitted altogether while remaining within the spirit and scope of the present disclosure.

FIG. 11 depicts an example process 1100 according to various embodiments. Process 1100 begins at operation 1105 where the UE 101 (or baseband circuitry of the UE 101) determines, based on a received configuration for a single carrier waveform at or above 52.6 GHz, configured time domain resources and configured frequency domain resources. At operation 1110, the UE 101 (or baseband circuitry of the UE 101) determines, based on received DCI, a time domain resource allocation and/or a frequency domain resource allocation for transmitting or receiving a data transmission (e.g., a PDSCH or PUSCH transmission). At operation 1115, the UE 101 (or RF circuitry of the UE 101) transmits or receives the data transmission according to the time domain resource allocation and the frequency domain resource allocation. The configured time domain resources and the time domain resource allocation may be the same or similar to the embodiments discussed previously with respect to FIGS. 3-6, and the configured frequency domain resources and the frequency domain resource allocation may be the same or similar to the embodiments discussed previously with respect to FIG. 7. After operation 1115, process 1100 ends or repeats as necessary.

FIG. 12 depicts an example process 1200 according to various embodiments. Process 1200 begins at operation 1205 where a RAN node 111 (or application circuitry and/or baseband circuitry of the RAN node 111) generates a configuration message for a single carrier waveform system operating at or above 52.6 GHz to indicate configured time domain resources and configured frequency domain resources. At operation 1210, the RAN node 111 (or RFEM(s) of the RAN node 111) transmits the configuration message to a UE 101 via higher layer signaling. At some later point, at operation 1215, the RAN node 111 (or application circuitry and/or baseband circuitry of the RAN node 111) generates DCI to indicate a time domain resource allocation and a frequency domain resource allocation for transmitting or receiving a data transmission. At operation 1220, the RAN node 111 (or RFEM(s) of the RAN node 111) transmits the DCI to the UE 101 to indicate activated ones of the configured time domain resources and configured frequency domain resources. The configured time domain resources and the time domain resource allocation may be the same or similar to the embodiments discussed previously with respect to FIGS. 3-6, and the configured frequency domain resources and the frequency domain resource allocation may be the same or similar to the embodiments discussed previously with respect to FIG. 7. After operation 1215, process 1200 ends or repeats as necessary.

Some non-limiting examples are as follows. The following examples pertain to further embodiments, and specifics in the examples may be used anywhere in one or more embodiments discussed previously. Any of the following examples may be combined with any other example or any embodiment discussed herein.

Example A01 includes a method of operating a System-on-Chip (SoC) to be implemented in a user equipment (UE) capable of communicating at frequencies above 52.6 gigahertz (GHz), the method comprising: determining, by baseband circuitry of the SoC based on Downlink Control Information (DCI) received via radiofrequency (RF) circuitry, a resource allocation for a data transmission scheduled by the DCI, the data transmission having a single carrier waveform at or above 52.6 GHz; and controlling, by the baseband circuitry, the RF circuitry via interface circuitry of the SoC to transmit or receive the data transmission according to the determined resource allocation, the interface circuitry communicatively coupling the baseband circuitry with the RF circuitry.

Example A02 includes the method of example A01, wherein the single carrier waveform includes a plurality of blocks where each block of the plurality of blocks includes a data portion and at least one guard interval (GI) positioned before the data portion and/or at least one GI positioned after the data portion, wherein the data portion of each block is divided into at least two sub-blocks, and wherein the data transmission is to take place within a sub-block of a block of the plurality of blocks.

Example A03 includes the method of example A02, wherein no GI is to be positioned between each sub-block of the at least two sub-blocks, only one GI is to be positioned between each sub-block of the at least two sub-blocks, or a GI is to be positioned before and after each sub-block of the at least two sub-blocks, such that two GIs are positioned between each sub-block.

Example A04 includes the method of example A03, wherein the GI is to include a unique word or a cyclic prefix.

Example A05 includes the method of example A04, wherein the resource allocation is to indicate a sub-block in which the data transmission is to be transmitted or received.

Example A06 includes the method of example A05, further comprising: determining, by the baseband circuitry based on higher layer signaling received via the RF circuitry, a GI configuration and one or more sub-block sizes, wherein the DCI is to indicate a selected sub-block size of the one or more sub-block sizes; and controlling, by the baseband circuitry, the RF circuitry via the interface circuitry to transmit or receive the data transmission during a time period corresponding to the selected sub-block size.

Example A07 includes the method of examples A01-A06, wherein the single carrier waveform includes a plurality of time domain resource blocks (TRBs) and the method further comprises: determining, by the baseband circuitry based on higher layer signaling received via the RF circuitry, a configuration that indicates N number of TRBs, wherein the DCI is to indicate one or more selected TRBs of the N number of TRBs; and controlling, by the baseband circuitry, the RF circuitry via the interface circuitry to transmit or receive the data transmission during one or more time units T_{c} corresponding to the one or more selected TRBs.

Example A08 includes the method of example A07, wherein the configuration is to indicate one or more TRBs of the N number of TRBs to be used as GIs.

Example A09 includes the method of examples A07-A08, wherein the method further comprises: determining, by the baseband circuitry, the N number of TRBs based on a slot duration or a TRB size indicated by the configuration.

Example A10 includes the method of examples A07-A09, wherein the resource allocation is a time domain resource allocation, and the method further comprises: determining, by the baseband circuitry based on a time domain resource assignment field in the DCI, a starting TRB relative to a start of a slot in which the data transmission is to be transmitted or received and an allocation length, wherein the allocation length is a number of consecutive TRBs counting from the starting TRB, and the number of consecutive TRBs are the one or more selected TRBs.

Example A11 includes the method of examples A07-A10, wherein the resource allocation is a time domain resource allocation, and the method further comprises: determining, by the baseband circuitry, a bitmap based on a time domain resource assignment field in the DCI, wherein the bitmap is to indicate the one or more selected TRBs.

Example A12 includes the method of examples A07-A11, wherein the configuration is to indicate one or more TRB groups (TBGs) each TBG of the one or more TBGs is a set of consecutive TRBs, the resource allocation is a time domain resource allocation, and the method further comprises: determining, by the baseband circuitry, a bitmap based on a time domain resource assignment field in the DCI, wherein the bitmap is to indicate one or more allocated TBGs; and determining, by the baseband circuitry, the set of consecutive TRBs of the one or more allocated TBGs based on the configuration and a bandwidth part (BWP) size.

Example A13 includes the method of examples A07-A12, wherein the resource allocation is a frequency domain resource allocation, and a frequency domain resource assignment field in the DCI does not include one or more of a VRB-to-PRB mapping field, a PRB bundling size field, and a frequency hopping field.

Example A14 includes the method of examples A01-A13, wherein the resource allocation is a frequency domain resource allocation, and the method further comprises:

determining, by the baseband circuitry based on a frequency domain resource assignment field in the DCI, an activated BWP from among one or more configured BWPs; and

determining, by the baseband circuitry, a starting location of the activated BWP based on an absolution frequency distance relative to a reference point of the single carrier waveform.

Example A15 includes the method of example A14, wherein the method further comprises: determining, by the baseband circuitry, a K value based on the frequency domain resource assignment field in the DCI or a received configuration; and determining, by the baseband circuitry, a bandwidth of the activated BWP based on a system BW and the K value.

Example A16 includes the method of examples A01-A15, wherein the single carrier waveform is a single carrier with frequency domain equalizer (SC-FDE) waveform.

Example A17 includes the method of examples A06-A16, wherein the higher layer signaling includes minimum system information (MSI) signaling, remaining MSI (RMSI) signaling, other system information (OSI) signaling, or radio resource control (RRC) signaling.

Example B01 includes a method to be performed by a user equipment (UE) capable of communicating at frequencies above 52.6 gigahertz (GHz), the method comprising: receiving Downlink Control Information (DCI); determining a resource allocation for a data transmission having a single carrier waveform at or above 52.6 GHz based on information included in the DCI; and communicating the data transmission according to the determined resource allocation, the communicating including transmitting or receiving the data transmission.

Example B02 includes the method of example B01, wherein the single carrier waveform includes a plurality of blocks where each block of the plurality of blocks includes a data portion and at least one guard interval (GI) positioned before the data portion and/or at least one GI positioned after the data portion, wherein the data portion of each block is divided into at least two sub-blocks, and wherein the data transmission is to take place within a sub-block of a block of the plurality of blocks.

Example B03 includes the method of example B02, wherein no GI is positioned between each sub-block of the at least two sub-blocks, only one GI is positioned between each sub-block of the at least two sub-blocks, or a GI is positioned before and after each sub-block of the at least two sub-blocks such that two GIs are positioned between each sub-block.

Example B04 includes the method of example B03, wherein the GI is to include a unique word or a cyclic prefix.

Example B05 includes the method of example B04, wherein the resource allocation is to indicate a sub-block in which the data transmission is to be transmitted or received.

Example B06 includes the method of example B05, further comprising: determining, based on higher layer signaling received, a GI configuration and one or more sub-block sizes, wherein the DCI is to indicate a selected sub-block size of the one or more sub-block sizes; and communicating the data transmission during a time period corresponding to the selected sub-block size.

Example B07 includes the method of examples B01-B06, wherein the single carrier waveform includes a plurality of time domain resource blocks (TRBs), and the method further comprises: determining, based on higher layer signaling, a configuration that indicates N number of TRBs, wherein the DCI is to indicate one or more selected TRBs of the N number of TRBs; and communicating the data transmission during one or more time units T_{c} corresponding to the one or more selected TRBs.

Example B08 includes the method of example B07, wherein the configuration is to indicate one or more TRBs of the N number of TRBs to be used as GIs.

Example B09 includes the method of examples B07-B08, wherein the method further comprises: determining the N number of TRBs based on a slot duration or a TRB size indicated by the configuration.

Example B10 includes the method of examples B07-B09, wherein the resource allocation is a time domain resource allocation, and the method further comprises: determining, based on a time domain resource assignment field in the DCI, a starting TRB relative to a start of a slot in which the data transmission is to be transmitted or received and an allocation length, wherein the allocation length is a number of consecutive TRBs counting from the starting TRB, and the number of consecutive TRBs are the one or more selected TRBs.

Example B11 includes the method of examples B07-B10, wherein the resource allocation is a time domain resource allocation, and the method further comprises: Determining a bitmap based on a time domain resource assignment field in the DCI, wherein the bitmap is to indicate the one or more selected TRBs.

Example B12 includes the method of examples B07-B11, wherein the configuration is to indicate one or more TRB groups (TBGs) each TBG of the one or more TBGs is a set of consecutive TRBs, the resource allocation is a time domain resource allocation, and the method further comprises: determining a bitmap based on a time domain resource assignment field in the DCI, wherein the bitmap is to indicate one or more allocated TBGs; and determining the set of consecutive TRBs of the one or more allocated TBGs based on the configuration and a bandwidth part (BWP) size.

Example B13 includes the method of examples B07-B12, wherein the resource allocation is a frequency domain resource allocation, and a frequency domain resource assignment field in the DCI does not include one or more of a VRB-to-PRB mapping field, a PRB bundling size field, and a frequency hopping field.

Example B14 includes the method of examples B01-B13, wherein the resource allocation is a frequency domain resource allocation, and the method further comprises: determining, based on a frequency domain resource assignment field in the DCI, an activated BWP from among one or more configured BWPs; and determining a starting location of the activated BWP based on an absolution frequency distance relative to a reference point of the single carrier waveform.

Example B15 includes the method of example B14, wherein the method further comprises: determining a K value based on the frequency domain resource assignment field in the DCI or a received configuration; and determining a bandwidth of the activated BWP based on a system BW and the K value.

Example B16 includes the method of examples B01-B15, wherein the single carrier waveform is a single carrier with frequency domain equalizer (SC-FDE) waveform.

Example B17 includes the method of examples B06-B16, wherein the higher layer signaling includes minimum system information (MSI) signaling, remaining MSI (RMSI) signaling, other system information (OSI) signaling, or radio resource control (RRC) signaling.

Example C01 includes a method of operating a Radio Access Network (RAN) node capable of communicating at frequencies above 52.6 gigahertz (GHz), the method comprising:

generating Downlink Control Information (DCI) to indicate a resource allocation for a data transmission, the data transmission having a single carrier waveform at or above 52.6 GHz; and

communicating the DCI to a user equipment (UE) and for transmitting or receiving the data transmission according to the resource allocation.

Example C01 includes the method of example C01, wherein the single carrier waveform includes a plurality of blocks where each block of the plurality of blocks includes a data portion and at least one guard interval (GI) wherein the RAN node further comprises: inserting a unique word or a cyclic prefix into the at least one GI; partitioning the data portion of each block into at least two sub-blocks; multiplexing a number UEs within the data portion of each block such that each UE of the number of UEs is to communicate data within a respective sub-block, wherein the data transmission is to take place within a sub-block of a block of the plurality of blocks, and the resource allocation is to indicate the sub-block in which the data transmission is to be transmitted or received; and generating the single carrier waveform such that no GI is to be positioned between each sub-block of the at least two sub-blocks, only one GI is to be positioned between each sub-block of the at least two sub-blocks, or a GI is to be positioned before and after each sub-block of the at least two sub-blocks such that two GIs are positioned between each sub-block.

Example C03 includes the method of example C02, further comprising: generating a configuration to indicate a GI type and one or more sub-block sizes; generating the DCI to indicate a selected sub-block size of the one or more sub-block sizes indicated by the configuration; and transmitting the configuration to the UE via higher layer signaling, and for communicating the data transmission during a time period corresponding to the selected sub-block size.

Example C04 includes the method of example C01, wherein the plurality of blocks and sub-blocks of the blocks of the plurality of blocks are expressed in as a plurality of time domain resource blocks (TRBs) and wherein generating the configuration includes generating the configuration to indicate N number of TRBs including one or more TRBs of the N number of TRBs to be used as GIs, and generating the DCI to indicate one or more selected TRBs of the N number of TRBs; and wherein the communicating includes communicating the data transmission during one or more time units T_{c} corresponding to the one or more selected TRBs.

Example C05 includes the method of example C04, wherein generating the DCI includes generating the DCI to include a time domain resource assignment field including information for the UE to determine a starting TRB relative to a start of a slot in which the data transmission is to be transmitted or received and an allocation length, wherein the allocation length is a number of consecutive TRBs counting from the starting TRB, and the number of consecutive TRBs are the one or more selected TRBs.

Example C06 includes the method of example C04, wherein the configuration is to indicate one or more TRB groups (TBGs) each TBG of the one or more TBGs is a set of consecutive TRBs, and generating the DCI includes generating the DCI to include a time domain resource assignment field including information for the UE to determine a bitmap based on a time domain resource assignment field in the DCI, wherein the bitmap is to indicate one or more allocated TBGs wherein the set of consecutive TRBs of the one or more allocated TBGs is based on the configuration and a bandwidth part (BWP) size.

Example C07 includes the method of examples C04-C06, wherein generating the DCI includes generating the DCI to include a frequency domain resource assignment field and to not include one or more of a VRB-to-PRB mapping field, a PRB bundling size field, and a frequency hopping field.

Example C08 includes the method of example C07, wherein the frequency domain resource assignment field in the DCI indicating an activated BWP from among one or more configured BWPs, and generating the DCI includes generating the DCI to include a K value, the K value to be used for determination of a starting location of the activated BWP based on an absolution frequency distance relative to a reference point of the single carrier waveform, and for determination of a bandwidth of the activated BWP.

Example C09 includes the method of examples C01-008, wherein the single carrier waveform is a single carrier with frequency domain equalizer (SC-FDE) waveform.

Example C10 includes the method of examples C03-C09, wherein the higher layer signaling includes minimum system information (MSI) signaling, remaining MSI (RMSI) signaling, other system information (OSI) signaling, or radio resource control (RRC) signaling.

Example Z01 may include an apparatus comprising means to perform one or more elements of a method described in or related to any of examples A01-A17, B01-B17, C01-C10, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A01-A17, B01-B17, C01-C10, or any other method or process described herein.

Example Z03 may include an apparatus comprising logic, modules, or circuitry to perform one or more elements of a method described in or related to any of examples A01-A17, B01-B17, C01-C10, or any other method or process described herein.

Example Z04 may include a method, technique, or process as described in or related to any of examples A01-A17, B01-B17, C01-C10, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A01-A17, B01-B17, C01-C10, or portions thereof.

Example Z06 may include a signal as described in or related to any of examples A01-A17, B01-B17, C01-C10, or portions or parts thereof.

Example Z07 may include a datagram, packet, frame, segment, protocol data unit (PDU), or message as described in or related to any of examples A01-A17, B01-B17, C01-C10, or portions or parts thereof, or otherwise described in the present disclosure.

Example Z08 may include a signal encoded with data as described in or related to any of examples A01-A17, B01-B17, C01-C10, or portions or parts thereof, or otherwise described in the present disclosure.

Example Z09 may include a signal encoded with a datagram, packet, frame, segment, protocol data unit (PDU), or message as described in or related to any of examples A01-A17, B01-B17, C01-C10, or portions or parts thereof, or otherwise described in the present disclosure. Example Z10 may include an electromagnetic signal carrying computer-readable instructions, wherein execution of the computer-readable instructions by one or more processors is to cause the one or more processors to perform the method, techniques, or process as described in or related to any of examples A01-A17, B01-B17, C01-C10, or portions thereof.

Example Z11 may include a computer program comprising instructions, wherein execution of the program by a processing element is to cause the processing element to carry out the method, techniques, or process as described in or related to any of examples A01-A17, B01-B17, C01-C10, or portions thereof.

Example Z12 may include a signal in a wireless network as shown and described herein. Example Z13 may include a method of communicating in a wireless network as shown and described herein. Example Z14 may include a system for providing wireless communication as shown and described herein. Example Z15 may include a device for providing wireless communication as shown and described herein.

Any of the above-described examples may be combined with any other example (or combination of examples), unless explicitly stated otherwise. The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous. The term “coupled” (or variants thereof) may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “communicatively coupled” may mean that two or more elements may be in contact with one another by a means of communication including through a wire or other interconnect connection, through a wireless communication channel or ink, and/or the like.

The foregoing description provides illustration and description of various example embodiments, but is not intended to be exhaustive or to limit the scope of embodiments to the precise forms disclosed. Modifications and variations are possible in light of the above teachings or may be acquired from practice of various embodiments. Where specific details are set forth in order to describe example embodiments of the disclosure, it should be apparent to one skilled in the art that the disclosure can be practiced without, or with variation of, these specific details. It should be understood, however, that there is no intent to limit the concepts of the present disclosure to the particular forms disclosed, but on the contrary, the intention is to cover all modifications, equivalents, and alternatives consistent with the present disclosure and the appended claims.

1.-25. (canceled)

26. A System-on-Chip (SoC) to be implemented in a user equipment (UE) capable of communicating at frequencies above 52.6 gigahertz (GHz), the SoC comprising:
interface circuitry; and
baseband circuitry coupled with the interface circuitry, the interface circuitry to communicatively couple the baseband circuitry to radiofrequency (RF) circuitry, the baseband circuitry to:
determine, based on Downlink Control Information (DCI) received via the RF circuitry, a resource allocation for a data transmission scheduled by the DCI, the data transmission having a single carrier waveform at or above 52.6 GHz, and
control the RF circuitry to transmit or receive the data transmission according to the determined resource allocation.

27. The SoC of claim 26, wherein the single carrier waveform includes a plurality of blocks where each block of the plurality of blocks includes a data portion and at least one guard interval (GI) positioned before the data portion and/or at least one GI positioned after the data portion, wherein the data portion of each block is divided into at least two sub-blocks, and wherein the data transmission is to take place within a sub-block of a block of the plurality of blocks, wherein the resource allocation is to indicate a sub-block in which the data transmission is to be transmitted or received.

28. The SoC of claim 27, wherein no GI is to be positioned between each sub-block of the at least two sub-blocks, only one GI is to be positioned between each sub-block of the at least two sub-blocks, or a GI is to be positioned before and after each sub-block of the at least two sub-blocks, such that two GIs are positioned between each sub-block, wherein the GI is to include a unique word or a cyclic prefix.

29. The SoC of claim 28, wherein the baseband circuitry is further to:
determine, based on higher layer signaling received via the RF circuitry, a GI configuration and one or more sub-block sizes, wherein the DCI is to indicate a selected sub-block size of the one or more sub-block sizes; and
control the RF circuitry to transmit or receive the data transmission during a time period corresponding to the selected sub-block size.

30. The SoC of claim 26, wherein the single carrier waveform includes a plurality of time domain resource blocks (TRBs) and wherein the baseband circuitry is further to:
determine, based on higher layer signaling received via the RF circuitry, a configuration that indicates N number of TRBs, wherein the DCI is to indicate one or more selected TRBs of the N number of TRBs; and
control the RF circuitry to transmit or receive the data transmission during one or more time units T_{c} corresponding to the one or more selected TRBs.

31. The SoC of claim 30, wherein the configuration is to indicate one or more TRBs of the N number of TRBs to be used as GIs, and the baseband circuitry is further to:
determine the N number of TRBs based on a slot duration or a TRB size indicated by the configuration.

32. The SoC of claim 30, wherein the resource allocation is a time domain resource allocation, and the baseband circuitry is further to:
determine, based on a time domain resource assignment field in the DCI, a starting TRB relative to a start of a slot in which the data transmission is to be transmitted or received and an allocation length, wherein the allocation length is a number of consecutive TRBs counting from the starting TRB, and the number of consecutive TRBs are the one or more selected TRBs.

33. The SoC of claim 30, wherein the configuration is to indicate one or more TRB groups (TBGs) each TBG of the one or more TBGs is a set of consecutive TRBs, the resource allocation is a time domain resource allocation, and the baseband circuitry is further to:
determine a bitmap based on a time domain resource assignment field in the DCI, wherein the bitmap is to indicate one or more allocated TBGs; and
determine the set of consecutive TRBs of the one or more allocated TBGs based on the configuration and a bandwidth part (BWP) size.

34. The SoC of claim 30, wherein the resource allocation is a frequency domain resource allocation, and a frequency domain resource assignment field in the DCI does not include one or more of a VRB-to-PRB mapping field, a PRB bundling size field, and a frequency hopping field.

35. The SoC of claim 34, wherein the baseband circuitry is further to:
determine, based on a frequency domain resource assignment field in the DCI, an activated BWP from among one or more configured BWPs; and
determine a starting location of the activated BWP based on an absolution frequency distance relative to a reference point of the single carrier waveform.

36. The SoC of claim 35, wherein the baseband circuitry is further to:
determine a K value based on the frequency domain resource assignment field in the DCI or a received configuration; and
determine a bandwidth of the activated BWP based on a system BW and the K value.

37. The SoC of claim 26, wherein the single carrier waveform is a single carrier with frequency domain equalizer (SC-FDE) waveform.

38. The SoC of claim 29, wherein the higher layer signaling includes minimum system information (MSI) signaling, remaining MSI (RMSI) signaling, other system information (OSI) signaling, or radio resource control (RRC) signaling.

39. One or more non-transitory computer-readable media (NTCRM) comprising instructions, wherein execution of the instructions by one or more processors is to cause a user equipment (UE) capable of communicating at frequencies above 52.6 gigahertz (GHz) to:
receive Downlink Control Information (DCI);
determine, based on the DCI, a resource allocation for a data transmission, the data transmission having a single carrier with frequency domain equalizer (SC-FDE) waveform at or above 52.6 GHz; and
control communication of the data transmission according to the determined resource allocation, the communication including transmission or reception of the data transmission.

40. The one or more NTCRM of claim 39, wherein the SC-FDE includes a plurality of time domain resource blocks (TRBs) and wherein execution of the instructions is to cause the UE to:
determine, based on received higher layer signaling, a configuration that indicates N number of TRBs, wherein the DCI is to indicate one or more selected TRBs of the N number of TRBs, wherein the higher layer signaling includes minimum system information (MSI) signaling, remaining MSI (RMSI) signaling, other system information (OSI) signaling, or radio resource control (RRC) signaling; and
control communication of the data transmission during one or more time units τ, corresponding to the one or more selected TRBs.

41. The one or more NTCRM of claim 40, wherein the configuration is to indicate one or more TRBs of the N number of TRBs to be used as GIs, and wherein execution of the instructions is to cause the UE to:
determine the N number of TRBs based on a slot duration or a TRB size indicated by the configuration.

42. The one or more NTCRM of claim 40, wherein the resource allocation is a time domain resource allocation, and wherein execution of the instructions is to cause the UE to:
determine, based on a time domain resource assignment field in the DCI, a starting TRB relative to a start of a slot in which the data transmission is to be transmitted or received and an allocation length, wherein the allocation length is a number of consecutive TRBs counting from the starting TRB, and the number of consecutive TRBs are the one or more selected TRBs.

43. The one or more NTCRM of claim 40, wherein the configuration is to indicate one or more TRB groups (TBGs) each TBG of the one or more TBGs is a set of consecutive TRBs, the resource allocation is a time domain resource allocation, and wherein execution of the instructions is to cause the UE to:
determine a bitmap based on a time domain resource assignment field in the DCI, wherein the bitmap is to indicate one or more allocated TBGs; and
determine the set of consecutive TRBs of the one or more allocated TBGs based on the configuration and a bandwidth part (BWP) size.

44. The one or more NTCRM of claim 40, wherein the resource allocation is a frequency domain resource allocation, and a frequency domain resource assignment field in the DCI does not include one or more of a VRB-to-PRB mapping field, a PRB bundling size field, and a frequency hopping field, and execution of the instructions is to cause the UE to:
determine, based on a frequency domain resource assignment field in the DCI, an activated BWP from among one or more configured BWPs; and
determine a starting location of the activated BWP based on an absolution frequency distance relative to a reference point of the SC-FDE.

45. The one or more NTCRM of claim 44, wherein execution of the instructions is to cause the UE to:
determine a K value based on the frequency domain resource assignment field in the DCI or a received configuration; and
determine a bandwidth of the activated BWP based on a system BW and the K value.

46. A Radio Access Network (RAN) node capable of communicating at frequencies above 52.6 gigahertz (GHz), the RAN node comprising:
processor circuitry to generate Downlink Control Information (DCI) to indicate a resource allocation for a data transmission, the data transmission having a single carrier waveform at or above 52.6 GHz; and
interface circuitry communicatively coupled with the processor circuitry, the interface circuitry to:
communicate the DCI to a user equipment (UE); and
communicate the data transmission according to the resource allocation.

47. The RAN node of claim 46, wherein the single carrier waveform includes a plurality of blocks where each block of the plurality of blocks includes a data portion and at least one guard interval (GI), wherein the processor circuitry is further to:
insert a unique word or a cyclic prefix into the at least one GI;
partition the data portion of each block into at least two sub-blocks; and
multiplex a number UEs within the data portion of each block such that each UE of the number of UEs is to communicate data within a respective sub-block, wherein the data transmission is to take place within a sub-block of a block of the plurality of blocks, and the resource allocation is to indicate the sub-block in which the data transmission is to be transmitted or received, and
the interface circuitry is further to generate the single carrier waveform such that no GI is to be positioned between each sub-block of the at least two sub-blocks, only one GI is to be positioned between each sub-block of the at least two sub-blocks, or a GI is to be positioned before and after each sub-block of the at least two sub-blocks such that two GIs are positioned between each sub-block.

48. The RAN node of claim 47, wherein:
the processor circuitry is further to:
generate a configuration to indicate a GI type and one or more sub-block sizes, and
generate the DCI to indicate a selected sub-block size of the one or more sub-block sizes indicated by the configuration; and
the interface circuitry is further to:
transmit the configuration to the UE via higher layer signaling, and
communicate the data transmission during a time period corresponding to the selected sub-block size.

49. The RAN node of claim 46, wherein the plurality of blocks and sub-blocks of the blocks of the plurality of blocks are expressed in as a plurality of time domain resource blocks (TRBs) and wherein:
the processor circuitry is further to:
generate the configuration to indicate N number of TRBs including one or more TRBs of the N number of TRBs to be used as GIs, and
generate the DCI to indicate one or more selected TRBs of the N number of TRBs; and
the interface circuitry is further to communicate the data transmission during one or more time units T_{c} corresponding to the one or more selected TRBs.

50. The RAN node of claim 49, wherein the processor circuitry is further to:
generate the configuration to indicate one or more TRB groups (TBGs) each TBG of the one or more TBGs is a set of consecutive TRBs; and
generate the DCI to include a time domain resource assignment field including information for the UE to determine a bitmap based on a time domain resource assignment field in the DCI, wherein the bitmap is to indicate one or more allocated TBGs wherein the set of consecutive TRBs of the one or more allocated TBGs is based on the configuration and a bandwidth part (BWP) size.
